(19) United States
(12) Patent Application Publication
(10) Pub. No.: US 2026/0310659 A1
(43) Pub. Date: Oct. 8, 2026

(54) SYSTEMS AND METHODS FOR AUTOMATED MODEL GENERATION

(71) Applicant: Kobai, Inc., San Ramon, CA (US)

(72) Inventor: Ryan Oattes, Burlington (CA)

(21) Appl. No.: 19/640,826

(22) Filed: Apr. 7, 2026

Related U.S. Application Data
(60) Provisional application No. 63/784,481, filed on Apr. 7, 2025.

(51) Int. Cl. G06F 16/242; G06F 16/248; G06F 16/28

(52) U.S. Cl. CPC G06F 16/2428; G06F 16/248; G06F 16/285

(57) ABSTRACT

A method for automated model generation is disclosed. The methods and system comprise generating tags from an accessed data source. Each tag may be marked structure class, structure attribute class, record class, or record attribute class. The methods and systems further includes generating (e.g., using an LLM), a vector embedding for each tag, and comparing the generated vector embeddings to generate match confidence levels used to generate different candidate groups. The methods and system also include generating for display a user interface that hierarchically represents each grouping, and adjusting it based on user input. The methods and systems additionally generate a semantic structure comprising classes, attributes, and class links based on the adjusted groupings and provide an interface for answering semantic queries based on the generated semantic structure.

### CROSS REFERENCE TO RELATED APPLICATIONS

This application claims priority to U.S. Provisional Application No. 63/784,481, filed Apr. 7, 2025, which is herein incorporated by reference.

### BACKGROUND

This disclosure is related to systems and methods for automated model generation.

### SUMMARY

Data storage and retrieval systems face barriers to adopting emerging large-language-model (LLM)-based “chat interfaces” for answering questions. Problems include an inability to answer questions correctly across private (non-public) data (e.g., private databases); scale and cost issues associated with large-scale adoption of vector databases leading to poor system performance; and a lack of transparency into the methodology, which prevents evaluating the validity of LLM-provided answers. For example, when an LLM produces a chatbot answer, there is no proof or evidence of correctness, and the answer can easily be an AI hallucination. This defeats the purpose of using the LLM, as the answer cannot be relied upon, nor can troubleshooting be performed for poor answers. Worse, the same query can produce different answers with no way to verify the answers with underlying data. On the other hand, using non-LLM search tools for searching large table-based data sources can be computationally heavy, and ineffective if the tables lack semantic organization. In some approaches, tables may need to be manually organized by user interface inputs, which is a slow task and not guaranteed to produce good results for large data sets. Accordingly, there is a need for automatic organization of data into semantic structures that are usable to answer questions.

To address these problems, methods and systems for generating semantic models (e.g., which may be trackable and/or verifiable in their generation) and/or answering questions using the semantic model are provided. In some embodiments, a method includes accessing at least one data source, which may include private databases or other non-public data sources. By accessing the underlying data source directly, the system may address the inability of conventional LLM chat interfaces to answer questions correctly across private data. This direct access may provide a technical benefit of enabling accurate responses grounded in the actual source data, rather than relying on pre-trained LLM knowledge that lacks visibility into private or proprietary information.

In some embodiments, the method includes extracting metadata from the at least one data source to generate a plurality of tags, wherein each of the plurality of tags is marked with one of a: structure class, structure attribute class, record class, and record attribute class. This extraction and classification of metadata may address the problem of tables lacking semantic organization by automatically categorizing data elements into a structured hierarchy. Rather than requiring manual organization by user interface inputs, which is slow and ineffective for large data sets, the system may automatically generate organized tags from the source data. This automated approach may provide technical benefits including reduced processing time, improved scalability for large data sets, and more consistent categorization compared to manual methods.

In some embodiments, the method includes generating, using an LLM, a vector embedding for each tag of the plurality of tags, and generating pairwise comparison data between the generated vector embeddings. By generating vector embeddings only for extracted tags rather than for entire data sources, the system may address scale and cost issues associated with large-scale adoption of vector databases. This reduces computing requirements, and improves system performance. The pairwise comparison data may be used to identify semantic relationships between data elements efficiently, enabling the system to find meaningful connections without the resource-intensive processing that would be required for embedding and comparing entire data sources.

In some embodiments, the method includes generating a set of candidate record groupings based on the pairwise comparison data, wherein match confidence levels are used to generate different candidate groups for the set of candidate record groupings. The use of match confidence levels may address the lack of transparency into methodology by providing verifiable metrics for how data elements are grouped. This transparency may allow users to evaluate the validity of the generated semantic structure, unlike conventional LLM answers that provide no proof or evidence of correctness. Technical benefits of this approach may include the ability to trace grouping decisions back to quantifiable similarity scores, enabling reproducible results and providing an audit trail that supports verification of the semantic model's accuracy.

In some embodiments, the method includes generating for display a user interface that hierarchically represents each grouping of the set of candidate record groupings, receiving input via the user interface for excluding at least one candidate record grouping from the set of candidate record groupings, and adjusting the candidate record groupings based on the input. This user interface interaction may address the problem of AI hallucinations and unverifiable answers by allowing users to review, verify, and adjust the automatically generated groupings early in the process. The hierarchical representation may provide visibility into how the semantic structure is formed, enabling troubleshooting that is not possible with conventional LLM chat interfaces. Technical benefits may include the ability to identify and correct erroneous groupings before they propagate into the final semantic model, reducing errors in downstream query results and improving overall system reliability.

In some embodiments, the method includes generating a semantic structure comprising classes, attributes, and class links based on the adjusted candidate record groupings, and providing an interface for answering semantic queries based on the generated semantic structure. The generated semantic structure may address the computational heaviness of non-LLM search tools by providing an organized, queryable model that enables efficient data retrieval. Because the semantic structure is generated through a trackable process with user verification, answers provided through the query interface may be verified against the underlying data, addressing the problem of inconsistent answers from conventional systems. Technical benefits may include faster query response times due to the organized semantic structure, consistent and repeatable query results, and the ability to validate answers by tracing them back through the verified semantic model to the original data sources.

In some embodiments, the method includes generating a semantic structure comprising classes, attributes, and class links based on the adjusted candidate record groupings, and providing an interface for answering semantic queries based on the generated semantic structure. The generated semantic structure may address the computational heaviness of non-LLM search tools by providing an organized, queryable model that enables efficient data retrieval. Because the semantic structure is generated through a trackable process with user verification, answers provided through the query interface may be verified against the underlying data, addressing the problem of inconsistent answers from conventional systems. Technical benefits may include faster query response times due to the organized semantic structure, consistent and repeatable query results, and the ability to validate answers by tracing them back through the verified semantic model to the original data sources. In some embodiments, queries may be constructed and answers provided using a semantic overlay data structure as described in U.S. Pat. No. 12,443,856 titled “Decision Intelligence System and Method,” which is incorporated herein by reference.

In some embodiments, rapid deployment of analytics to brownfield site data are provided, where the analytic system accepts a certain organizational data as input. In some embodiments, techniques described herein are used to present information on a UI interface in the model of user interface selected choice. In some embodiments, techniques are provided for development of a complex ontology that includes multiple “standard” or reference models as well as user input or preferences. In some embodiments, rapid configuration of data for consumption by artificial intelligence (AI)/large language model (LLM) query capabilities is provided. In some embodiments, Semantic Model as a Service is provided. In some embodiments, the system generates an improved data catalog based on enterprise data stores with minimal user interface intervention.

### BRIEF DESCRIPTION OF THE DRAWINGS

FIG. 1 is an example block diagram of an illustrative system and data storage for ontology-guided question answering techniques, in accordance with some embodiments of the disclosure.

FIG. 2 is an illustrative example of a data source and reference model as input for an ontology integration, in accordance with some embodiments of the disclosure.

FIG. 3A is an example block diagram of an illustrative system for generating models from one or more data sources, in accordance with some embodiments of the disclosure.

FIG. 3B is an example block diagram of an illustrative system for generating models from one or more data sources, in accordance with some embodiments of the disclosure.

FIG. 3C is an example block diagram of an illustrative system for generating models from one or more data sources, in accordance with some embodiments of the disclosure.

FIG. 3D is an example block diagram of an illustrative system for generating models from one or more data sources, in accordance with some embodiments of the disclosure.

FIG. 4 is an example structure from a database source, in accordance with some embodiments of the disclosure.

FIG. 5 is example structure attributes, in accordance with some embodiments of the disclosure.

FIG. 6 is example records, in accordance with some embodiments of the disclosure.

FIG. 7 is example record attributes, in accordance with some embodiments of the disclosure.

FIG. 8 is example tags from one or more database sources, in accordance with some embodiments of the disclosure.

FIG. 9 depicts example code lines for data source data processing, in accordance with some embodiments of the disclosure.

FIG. 10 is example local identifiers, in accordance with some embodiments of the disclosure.

FIG. 11 is example acronyms and domain vocabularies, in accordance with some embodiments of the disclosure.

FIG. 12 is example tag data after tokenization and categorization, in accordance with some embodiments of the disclosure.

FIG. 13 is example code for data augmentation, in accordance with some embodiments of the disclosure.

FIG. 14 is an example comparison configuration, in accordance with some embodiments of the disclosure.

FIG. 15 is example tag values with vectors, in accordance with some embodiments of the disclosure.

FIG. 16 depicts example code for vector generation, in accordance with some embodiments of the disclosure.

FIG. 17 is example match data, in accordance with some embodiments of the disclosure.

FIG. 18 is example match stats for an industrial asset model source, in accordance with some embodiments of the disclosure.

FIG. 19 depicts match stats from the same industrial asset model source, in accordance with some embodiments of the disclosure.

FIG. 20 is example code for generating matches function using child node types, in accordance with some embodiments of the disclosure.

FIG. 21 is example code to aggregate matches, in accordance with some embodiments of the disclosure.

FIG. 22 is example group statistics, in accordance with some embodiments of the disclosure.

FIG. 23 is example no parent data, in accordance with some embodiments of the disclosure.

FIG. 24 is example code for group regulation, in accordance with some embodiments of the disclosure.

FIG. 25 is example code for limiting the graph to edges meeting the confidence level and extracting connected groups, in accordance with some embodiments of the disclosure.

FIG. 26 is example code for optimization of the rollup coverage of the structure attribute or record attribute regulated groups, in accordance with some embodiments of the disclosure.

FIG. 27 depicts example group labeling, in accordance with some embodiments of the disclosure.

FIG. 28 is example code to generate hierarchy of groups, in accordance with some embodiments of the disclosure.

FIG. 29A is an example user interface for database models, in accordance with some embodiments of the disclosure.

FIG. 29B is an example user interface for database models, in accordance with some embodiments of the disclosure.

FIG. 30 is an example user interface, in accordance with some embodiments of the disclosure.

FIG. 31A depicts an example device to provide data processing and visualization, in accordance with some embodiments of the disclosure.

FIG. 31B depicts a diagram of an illustrative system for performing data analysis and user interface presentation, in accordance with embodiments of this disclosure.

FIG. 32 is an example semantic model and sub graphs, in accordance with embodiments of this disclosure.

FIG. 33 is an example flowchart of a method for automated model generation, in accordance with some embodiments of the disclosure.

### DETAILED DESCRIPTION

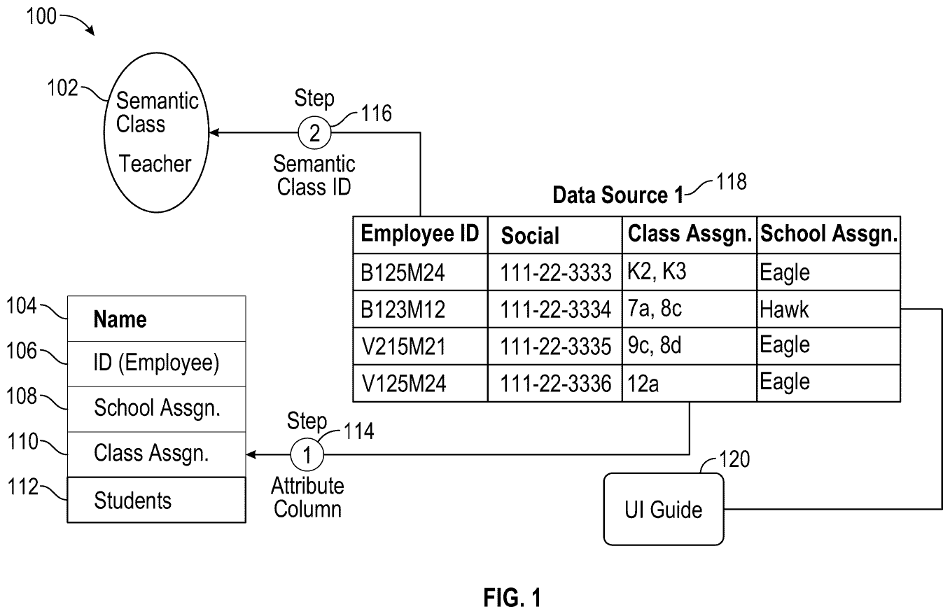

FIG. 1 depicts an example mapping processes 100 for creating a semantic overlay data structure, in accordance with some embodiments of the disclosure. In some embodiments, the mapping process may be performed by a Data Processing Application (the DPA). In some approaches, the DPA is embodied in a set of instructions stored in non-volatile memory of a single server or in a set of servers acting in parallel (e.g., in a distributed computing environment). The processors of the server or servers may execute the instructions stored in non-volatile memory to allow operation of the DPA. In some examples, the DPA may interface with data stored locally or on a remote device or devices accessible via at least one network.

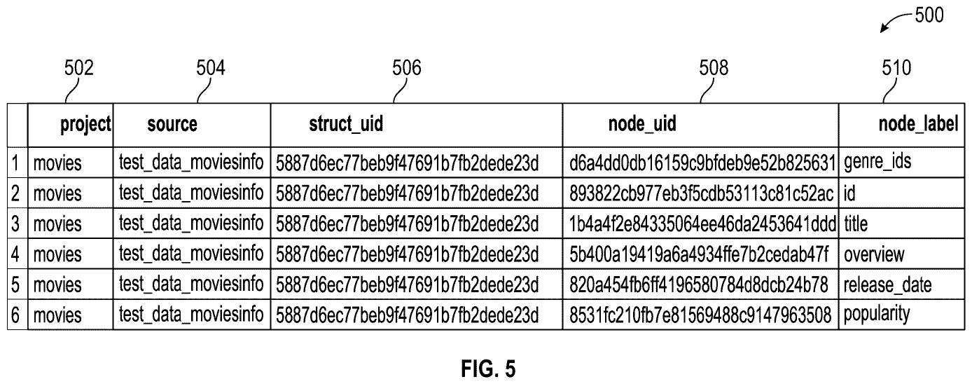

In the example shown in FIG. 1, mapping processes 100 may correspond to a manual or semi-manual ingestion process. Additional figures and description are provided herein for fully automatically or partially automatically creation of a semantic overlay data structure by the DPA (e.g., with limited user input). For example, specifically designed heuristic and/or AI tools may be used to create potential concept semantic trees. In some embodiments, the trees may be truncated based on UI input as shown in FIGS. 4-5 below. Such trees may then be used for automated creation of semantic overlay data structure, providing additional improvements when compared to ingestion process described below in relation to FIG. 1.

The systems and methods performed by the DPA described herein generate and/or use a semantic overlay data structure (which may also be referred to as a semantic model) that provides a level of abstraction for traditional data sources (e.g., tables, database, lists), such as first data source 118. The method of creating overlay data structures is described in more detail in the '857 Publication (U.S. Patent Publication No. 2020-0210857 incorporated herein by reference). For example, first data source 118 may comprise a table listing data for teachers in a school district. As shown, first data source 118 includes several columns for multiple teachers, such as social security number, class assignment, school assignment, etc. One skilled in the art would appreciate that such a table may include any suitable number of columns tracking any suitable data for teachers in the school districts. In some embodiments, rows may be used to track data instead of or in addition to columns.

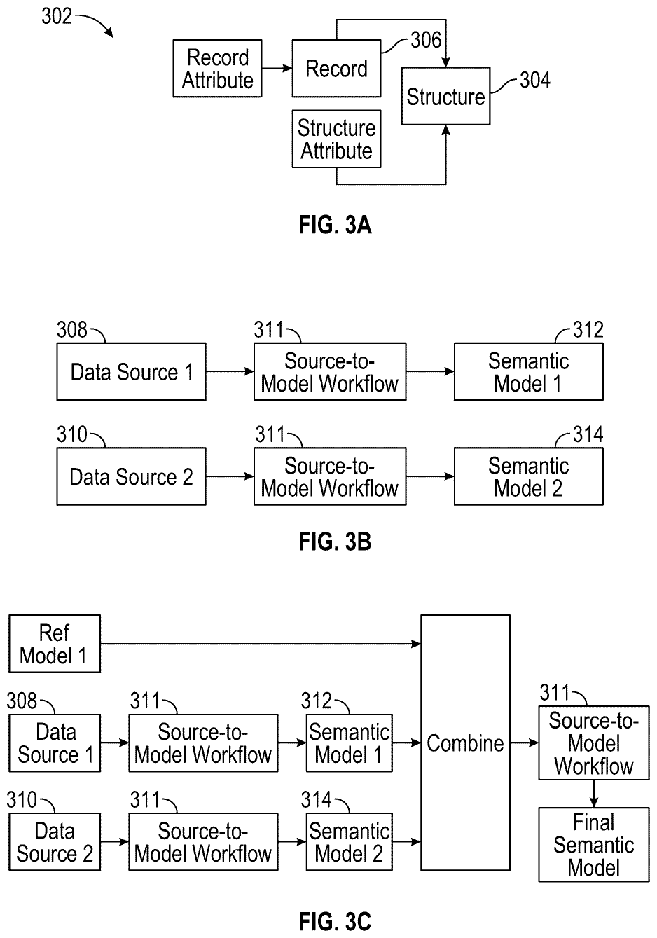

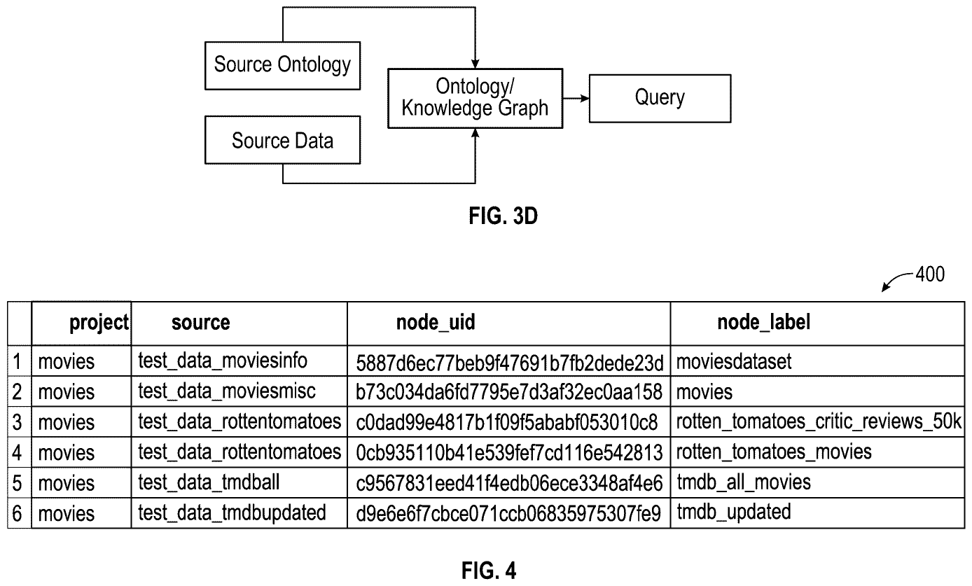

In some embodiments, the DPA may operate to ingest first data source 118 (e.g., and any other traditional data sources) into a semantic overlay data structure. The semantic overlay data structure may define a plurality of semantic classes (e.g., “teacher,” “school,” “student”). Some exemplary semantic classes are further shown, e.g., in FIG. 3 of the present disclosure. Each semantic class may comprise a list of attributes. For example, the semantic class 102 (e.g., “teacher”) may comprise a name attribute 104, ID attribute 106, school assignment attribute 108, class assignment attribute 110, students attribute 112, combinations of the same, or the like. One or more of the attributes may be connection to other semantic classes. For example, the students attribute 112 may be a link to one or more semantic classes'instances of the semantic class “Student” (e.g., by linking to an ID of those instances). Similarly, the “school assignment” attribute 108 may be a link to one or more semantic classes'instances of the semantic class “School.” The semantic overlay data structure may be defined and stored as a graph data structure that identifies every semantic class in the model and indicates all connections between the semantic classes (e.g., as edges between nodes of a graph). The semantic overlay data structure may also define the list of attributes for every semantic class (e.g., as data stored in association with each node of the data structure). The semantic overlay data structure may be incrementally defined using User Interface (UI) Guide 120 (e.g., as further described in the '857 Publication). For example, the user interface input from UI guide 120 may create a number of nodes, name the nodes, and/or draw connections between the nodes. The user interface input from UI guide 120 may be used to define attributes for each node (e.g., by a user input of selecting a node, and/or user input of names of the attributes).

In some embodiments, each semantic class in the model may be associated with multiple instances of that semantic class. For example, as shown, four instances of semantic class 102 (e.g., “teacher”) may be created by the system based on four teachers being listed in the first data sources. In some examples, instances of semantic class 102 (e.g., “teacher”) may be created based on any number of traditional data sources. Each instance of semantic class 102 (e.g., “teacher”) may be assigned a semantic class instance ID. In some examples, the instance ID may be used by a search system to uniquely identify each class instance. Further, in some embodiments, instance IDs may be used to create unique links between semantic class instance (e.g., a link from an attribute may be defined to point to another semantic class instance, for example by storing ID of the linked semantic class instance as one of the attributes).

In some embodiments, the structure of the semantic overlay data structure is defined and data from one or more data sources (e.g., first data source 118) may be ingested into the semantic overlay data structure (e.g., to create sematic class instances for each defined sematic class). The ingestion process may be assisted using UI guide 120. For example, items in columns of first data source 118 are mapped to semantic class attributes 104-112. The user device that interfaces with the DPA may be prompted by UI guide 120 to perform the mapping. For example, UI Guide 120 may guide selections of data for attributes of semantic class 102. FIG. 1 illustrates an exemplary 2-step data mapping using UI guide 120. In one example, first step 114 corresponds to a selection of at least one column from a data source 118 (e.g., class assignment column) to provide attribute values for a selected attribute (e.g., class assignment attribute 110). Second step 116 corresponds to identifying the appropriate semantic class and appropriate attribute for the that class that is to be mapped to that column. Steps 114 and 116 may be performed in any order, or at the same time.

In some examples, the data is ingested from one or more data sources (e.g., first data source 118) into the semantic overlay data structure only when a query is received. In these examples, the sematic classes, attributes, and/or connections between the sematic classes may be defined ahead of time. The actual instances of the classes may be generated in real time when required (e.g., when a query if formed, such as at element 304 of FIG. 3). In some embodiments, a hybrid approach may be used, e.g., some data sources may be ingested ahead of time, while other data is ingested as needed.

For example, the illustrated example shows a mapping of “Class Assignment” attribute 110 in the semantic overlay data structure to the “Class Assgn” column in the Data Source 118 source table. In this example, a user interface can be used to drag “Class Assignment” attribute 110 over the “Class Assgn” Column of Data Source 118. In some embodiments, the user interface displays a prompt to identify how Data Source 118 relates to the semantic class 102 (e.g., “Employee”) in the overlay data structure. For example, the user interface may generate a prompt to indicate how each employee is uniquely identified in Data Source 118. In this case, the “Employee ID” column may be selected as unique identifier of sematic class “Teacher” instances (which may match “ID” attribute 104). For example, columns of the first data source 118 may be mapped to attributes of instances of semantic class 102. One skilled in the art would appreciate that this process may be performed for any number of data sources and for any attributes of any number of defined semantic class. For example, different columns of many different data sources may be mapped to attributes of semantic classes “teacher,” “school,” and “student.” In some embodiments, multiple columns of multiple data sources are mapped to the same attribute of the same semantic class. In such embodiments, the mapping may also define relations to other instances of other semantic classes. For example, the attribute “school assignment” may be mapped to instances of a semantic class “school” when a connection is defined between semantic class “teacher” and semantic class “school.”

In some embodiments, the ingestion of data from first data source 118 to the semantic overlay data structure that includes semantic class 102 is accomplished by the DPA creating and updating a triplestore purpose-built database for the storage and retrieval of data through semantic queries. For example, the DPA may create triples (which may also be referred to as “triads” or “3-tuples”) based on ingestion of data. For example, triples (e.g., triples suitable for SPARQL Protocol and RDF Query Language (SPARQL)) may include, for each instance of an attribute: unique ID of concept instance to which it belongs, the name of the attribute, the value of the attribute, combinations of the same, or the like. The triples may then be indexed and used for fast data retrieval. For example, the triples may be data triples defined by W3C RDF 1.1 N-Triples specification (https://www.w3.org/TR/n-triples/) which is herein incorporated into this document in its entirety.

In some embodiments, knowledge graphs or other non-graph semantic layers may be useful for complex organizations in managing data. For example, benefits may include data reuse by a search system; ease of access of data (e.g., access of data using simple user interface without the need to write data retrieval code); powerful integration with LLM technology·(e.g., as describe in U.S. Patent Application No. 63/706,986 titled “SYSTEM AND METHOD FOR KNOWLEDGE GRAPH EMBEDDING INTO AI MODEL” which is herein incorporated by reference); ability to leverage “Retrieval-Augmented Generation” (RAG) approaches for question answering; combinations of the same; or the like.

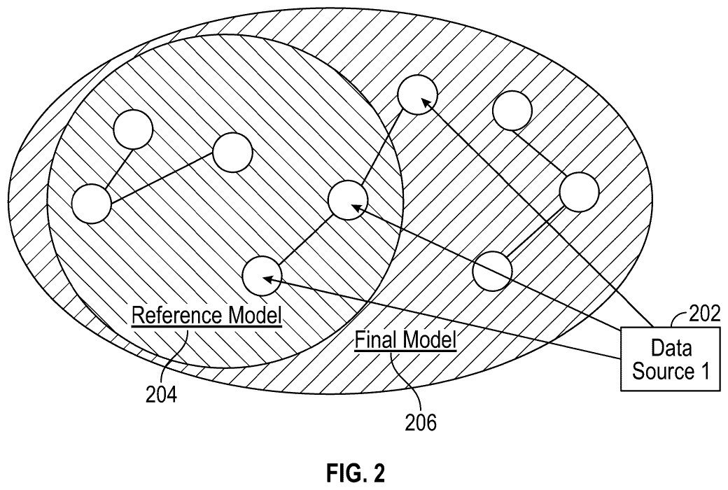

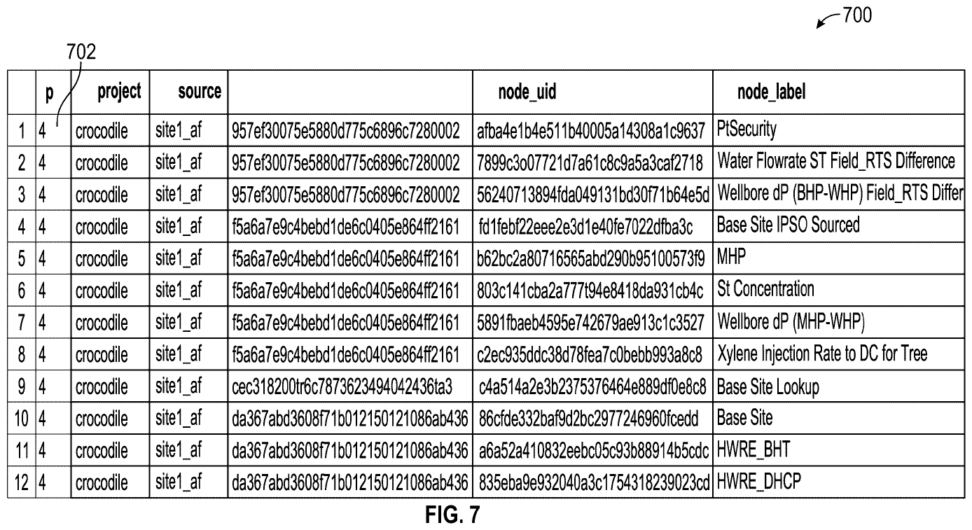

FIG. 2 is an illustrative example of a data source and reference model as input for an ontology integration, in accordance with some embodiments of the disclosure. In some embodiments, a process (e.g., executed by the DPA) for ontology integration can take as input one or more data sources (e.g., data source 202) and one or more reference models (e.g., reference model 204). In some examples, the DPA may generate a single semantic model (e.g., final model 206 of FIG. 1, and/or model 3250 of FIG. 7) and mapping instructions (e.g., which may be referred to herein as mappings) connecting final model 206 to any of the input data sources (e.g., instead of manual mapping process shown in FIG. 1).

In some examples, when input reference model 204 is provided, all of the reference model classes and attributes will appear in final model 206. For input data sources (e.g., data source 202), classes and attributes that appear in the final model 206 may account for all or most of the input data.

In some examples, the DPA utilizes various techniques described herein for determining (e.g., with a level of confidence) what data elements are the same as other data elements. For example, two input reference models having a class that are sufficiently similar may appear as the same class in the output final model. In some examples, if a first reference model has a similar class but with larger scope than a second reference model, there may be a subclass relationship in the output model. In some embodiments (e.g., to integrate a plurality of data sources), the DPA may generate a semantic model from each data source, and then integrate these generated models into the reference models. Data from a given data source may populate classes in the output model that are derived from reference models if there is sufficient similarity, and other data may end up in output classes fully constructed dynamically with no basis in the reference models.

In some embodiments, the DPA contains methods to compare and group similar data entities, which may allow them to be distilled into semantic classes and attributes. These atomic capabilities may be applied in any one or more approaches, e.g., using a process for efficient integration into ontologies.

FIGS. 3A-3D are example block diagrams of an illustrative system for generating models from one or more data sources, in accordance with some embodiments of the disclosure. In some examples, as shown in FIG. 3A, the DPA generates and/or establishes a structural meta model 302. As used herein, the terms Record (e.g., Record 306) and Structure (e.g., Structure 304) may refer to variety of suitable data structures. In some examples, record 306 may be a collection of related data. In some examples, structure 304 is a description of what data related records will contain. In some examples, structure 304 may be a class in an ontology, and record 306 may be a class instance. In another example, structure 304 could be a database table, and record 306 could be a row of data.

As shown in FIG. 3B, the DPA may take each of a plurality of input data sources (e.g., data source 308 and/or data source 310), and run them through a source-to-model workflow 311 (e.g., Per Data Source Orchestration), to generate for each a separate semantic model (e.g., semantic model 312 and semantic model 314 respectively). The data source 308 and the data source 310 may be run through the same source-to-model workflow 311. In some examples, the data source 308 and/or the data source 310 may be run through the source-to-model workflow 311 one at a time, at the same time, or in any order.

As shown in FIG. 3C, the DPA may adjust the framing, and re-run the source to model workflow (e.g., Per Data Source Orchestration), using semantic models (e.g., semantic model 312 and semantic model 314) as source data. Specifically, the DPA may include the semantic models derived from each individual data source (e.g., data source 308 and/or data source 310), and each of the reference models. The DPA may or may not treat each semantic model as a separate data source with a separate execution of the workflow. In embodiments where a single output model is required, the DPA may instead integrate/concatenate all of the models into a single larger source, and run the workflow once.

The “two pass” strategy (e.g., as shown in FIG. 3C) may be needed due to large size of the data sources (e.g., in the industrial and unstructured data spaces). The source-to-model workflow 311 may rely on connectivity graphs based on the cartesian product of nodes in the structural model. The size and complexity of these graphs may grow exponentially with the size of the data source, so being able to simplify these structures in a first pass is valuable. In embodiments where the DPA's inputs are constrained database/tabular data sources, a single pass approach may be preferred due to speed.

In some embodiments (e.g., as described with respect to FIGS. 3A-3D), the DPA uses a workflow that runs “per data source” that may be applied to any level within the structural model. In some examples, a particular order of operations that puts all steps together may be used by the DPA. In some examples, the DPA groups together either Records (e.g., Record 306) or Structures (e.g., Structure 304) to get classes for a semantic model, and then Record Attributes or Structure Attributes respectively for associated model attributes for those classes. In some implementations, the DPA uses a strategy where all metadata may be rolled up into Structures 304 before being grouped. As used herein, rolling up metadata may refer to aggregating data from a lower level in the structural model hierarchy to a parent level.

The workflows described with respect to FIGS. 3A-3D may be used when the DPA gets to the generation of matches. In some examples, before generation of matches, each step may be performed on each data source individually, and node types (e.g., structures vs records) may be handled independently. For example, an approach may comprise of any one or more of the following steps: extraction of metadata from data sources and reference models; enrichment of metadata, particularly in the classification of identifiers; vectorization of key metadata; generation of matches between entities; regulation and/or aggregation of matches; generation of groups across range of confidence levels, reduce and/or optimize these groups; generation and simplification of group hierarchy; generation group names; acquisition of user interface input; export of the model and mappings; combinations of the same; or the like.

In some embodiments, the DPA answers key questions corresponding to the data, such as “what does this data describe?” For example, a data record may be a sentence “Ryan has a son named Lachlan.” The DPA may use LLM processing to identify entities Ryan and Lachlan. In some examples, the DPA may assign class “People” to entities Ryan and Lachlan. The DPA may perform further analysis to determine that one is a special kind of “People” called “Son” and Ryan a special kind of “People” called “Father.” For this small record of data, the DPA acquired type information (Father) and some identifier information (Ryan) about Ryan. At another level, the DPA may analyze more sentences and determine that Frank is also a “Dad.” For example, the DPA may identify that Ryan and Frank have the same type, Dad/Father.

Metadata extraction approaches, among other concepts, are described as follows. In some embodiments, any type of data source may be included in the ontology generation process. For example, structured, semi-structured, unstructured sources, or the like, may be used in the ontology generation process (e.g., with widely varying metadata available to describe them). The DPA may first align source metadata to a “structural model”, allowing it to abstract out the variations in metadata. In some examples, this structural model consists of any one or more following structures, structural attributes, records, or record attributes, described herein.

FIG. 4 is an example structure 400 from a database source, in accordance with some embodiments of the disclosure. In some embodiments, structures (e.g., Structure 304 of FIG. 3, structure 400 of FIG. 4) may be defined as organized patterns of data storage or transmission. An example of a structure maybe be a table, a response from a given web service, or the like. In some semi-structured data, the concept of “templates” or “asset types” may be both used (e.g., both are examples of structures). In some embodiments, structures are not the same classes in the resulting semantic model. In some embodiments, when designing a database schema, relations/tables are frequently created for “things” and/or “events”, or other concepts that may make good classes in a semantic model. In some examples, some tables may only partially describe one of these classes (e.g., for reasons of database performance or due to the scope of the database schema in question), which results in a poor final model.

For example, a human resources (HR) database may have a table titled “people” (that intuitively should be directly tied to a semantic class of the same name) until the DPA discovers that another database contains a “students” table that extends the type of information we know about “people”. Similarly, it may be that a table describes multiple semantic classes. For example, if the HR database “people” table has columns for “country” and “street address”, the schema design decision may not be appropriate if it is desirable to have a single Address class in the semantic model (e.g., that combined address and country information).

FIG. 5 depicts example structure attributes, in accordance with some embodiments of the disclosure. In some embodiments, structure attributes may refer to descriptors of structures. For example, columns of a database table may correspond to structure attributes. They could also be the fields in a web service response. For example, as depicted in FIG. 5, structure attributes 502-510 correspond to structure 500.

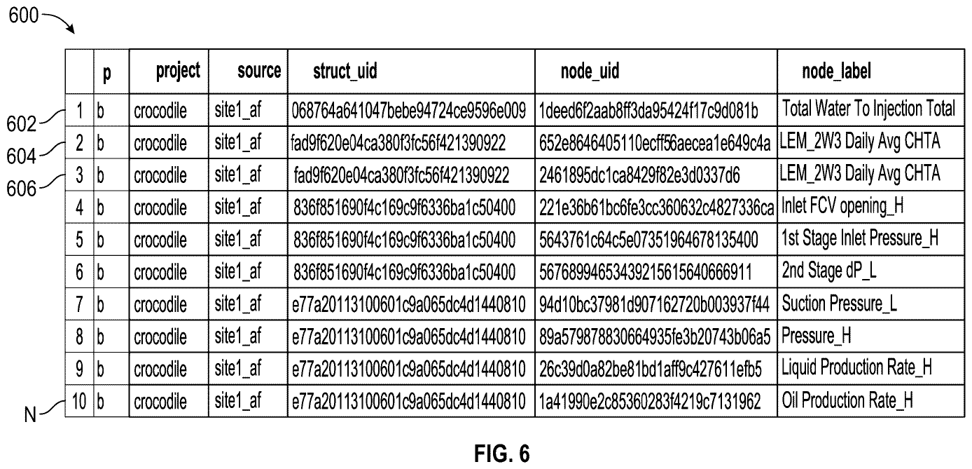

FIG. 6 is example records, in accordance with some embodiments of the disclosure. FIG. 6 depicts records from an industrial asset model source. FIG. 6 comprises structure 600 which comprises records 602, 604, 606. . . N. In some embodiments, records refer to instances of data, which may or may not be described by a structure. For example, records may be rows of a table, such as row/record 602 of structure 600. Records may be more complex than a simple “fact”, as in the case of records representing rows in a database table. For example, a use case for this technique may include semi-structured data describing assets in industrial facilities. In some examples, notation in an XML file may define “<asset>” data. If <asset> tags contain a link to, for example, a <template>, this may be a link between a record and a structure. Of the record, the DPA may only know that the various facts (or individual data points) are related in some way. In some embodiments, such as examples with unstructured data (e.g., a text document corpus), records may be constructed based on the proximity between data points.

FIG. 7 is example record attributes, in accordance with some embodiments of the disclosure. In some embodiments, record attributes refer to individual facts or data points comprising a Record. FIG. 7 depicts an example of record attributes from an industrial asset model source. For example, in structure 700, record attribute 702 is a data point.

In some embodiments, the structural model incorporates these four classes, structures, structure attributes, records, and record attributes, into a simple hierarchy (e.g., as shown in FIG. 3A).

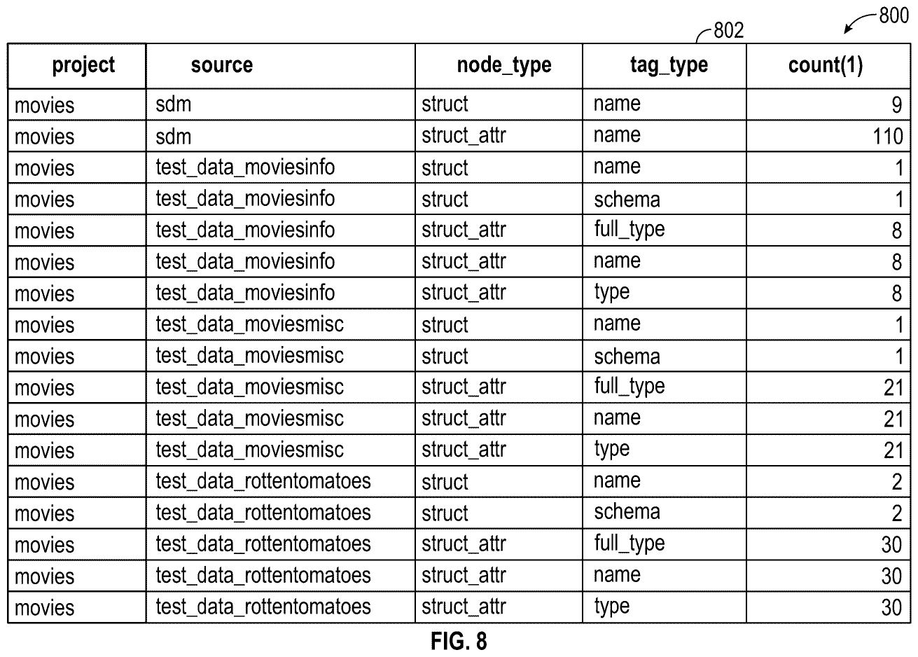

FIG. 8 is example tags from one or more database sources, in accordance with some embodiments. As depicted in FIG. 8, structure 800 comprises tag types in column 802, such as “name”, “schema”, and “full_type.” In addition or alternatively to the DPA simplifying details of data source schema into a structural model, the DPA may abstract out the variety of descriptive data available about each one as “tags”. In some examples, the minimum number of tags per data source is one. A tag may commonly be understood to be the “name” of the object. For example, implementations may use “name” and “description” as the starting point, and then add additional tags with specific meaning to the data source. Because these additional tags may not be present in every data source, the behavior of how they are subsequently used may be exposed as part of the process configuration. In some embodiments, the process for extracting data source metadata into the structural model differs for each type of data source.

In embodiments with table data sources (e.g., database tables) such as FIG. 8, each table may be a Structure, with a tag “name” containing the table name. The DPA may also add a tag called “schema” unique to tables containing the name of the database, which may be a useful clue into the meaning of the data. In some examples, each column in the table may be a Structure Attribute. Each of these may comprise a “name” tag and/or a “datatype” tag. In some embodiments, the data in each table may be sampled by the DPA to provide some Records and Record Attributes. Even though higher order metadata may be available (e.g., the table structure), this lower order data may be useful in determining the meaning of a table within the context of a semantic model.

In some examples, a Site Configuration type of data source includes a configuration for industrial process systems (e.g., SCADA, Historians, Asset Frameworks, etc.). These may be configured based on human entered descriptions in a free-form hierarchy. Nodes in the hierarchy may represent equipment, process steps, physical locations, and/or a logical aggregation of data about the others. They may or may not have a template system. For example, a “<AFElement>” tag may interpreted as a Record. Further, in such examples, the child tags, such as “<AFAttribute>” may comprise Record Attributes. The <Template> tag may be a pointer to a template definition. For example, templates may be ingested as Structures (e.g., which may have attributes as well, such as Structure Attributes). In embodiments of industrial control systems, additional tags may be exceptionally useful. Attributes related to industrial control systems may represent time-series data sampling stored in a time-series database. Each stream of data may have a “PI_tag”, which may be used relating individual attributes and entities.

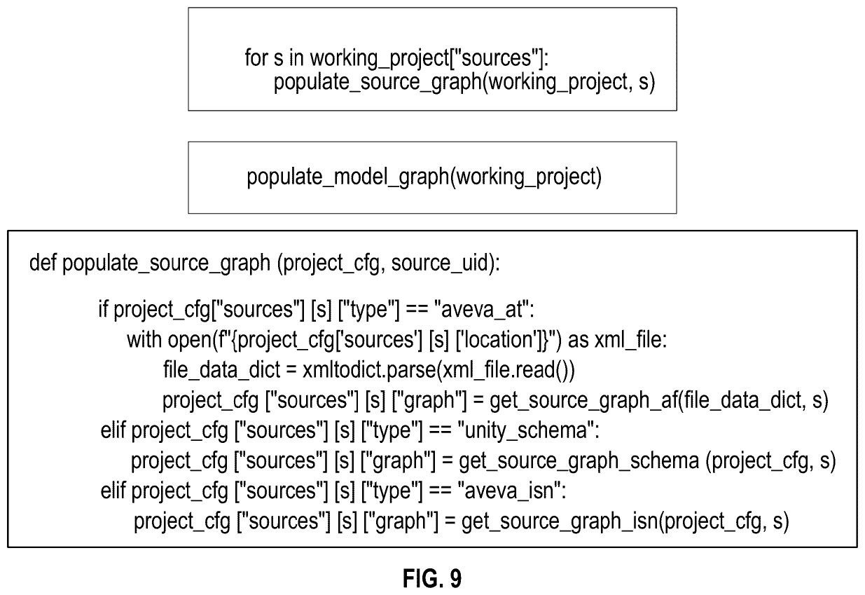

FIG. 9 is example code lines for data source data processing, in accordance with some embodiments. For example, the code lines of FIG. 9 may correspond to processing of any of the source columns in structures 400, 500, 600, 700, and/or 800, of FIGS. 4-8 respectively. The example code lines corresponding to FIG. 9 may be executed per data source.

Metadata enrichment approaches, among other concepts, are described as follows In some embodiments, challenges arise for extracting semantic models from data sources, because data source schema (e.g., table names, XML tags, etc.) are typically meant for machine consumption. Semantic models may be designed to express meaning, so identifiers in the metadata may have to be understood by the DPA, rather than just extracted. For example, in industrial use cases, jargon or acronyms may be used to describe data (e.g., even in fields like “description” that should be more understandable). To overcome these challenges, it is important for the DPA to unpack acronyms and abbreviations. In many “general” domains, an LLM could do this for us, but in specialized domains this may be challenging.

In some embodiments, any number of suitable resources may be used by the DPA to enrich metadata (e.g., for contextual understanding). For example, resources may be across all usage, or tailored to specific use cases and/or domains. In some embodiments, the DPA uses a dictionary. For example, a list of words may be used to determine if a token is a word and/or a more technical identifier that needs to be further unpacked. In some embodiments, the DPA may use a Domain Vocabulary. For example, the Domain Vocabulary may comprise specialized words (e.g., that may not appear in the dictionary, but nonetheless need to be identified as words).

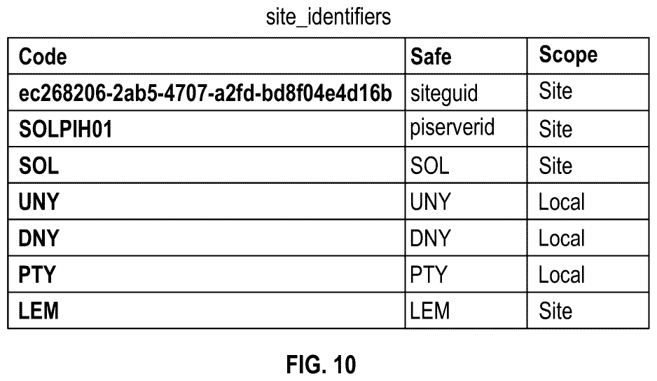

FIG. 10 is example local identifiers, in accordance with some embodiments. In some embodiments, the DPA uses Local Identifiers (e.g., acronyms) to enrich metadata and/or understand additional context. For example, Local Identifiers may comprise words or acronyms that refer to local items, e.g., not things part of the general domain of interest. For example, an industrial site might use the acronym “NWPL” to refer to the production line in the northwest corner of their facility. The DPA may be configured to avoid search for its meaning within the larger domain (e.g., oil & gas, manufacturing, etc.,). In some examples, a list and/or local identifiers may be provided via user interface input.

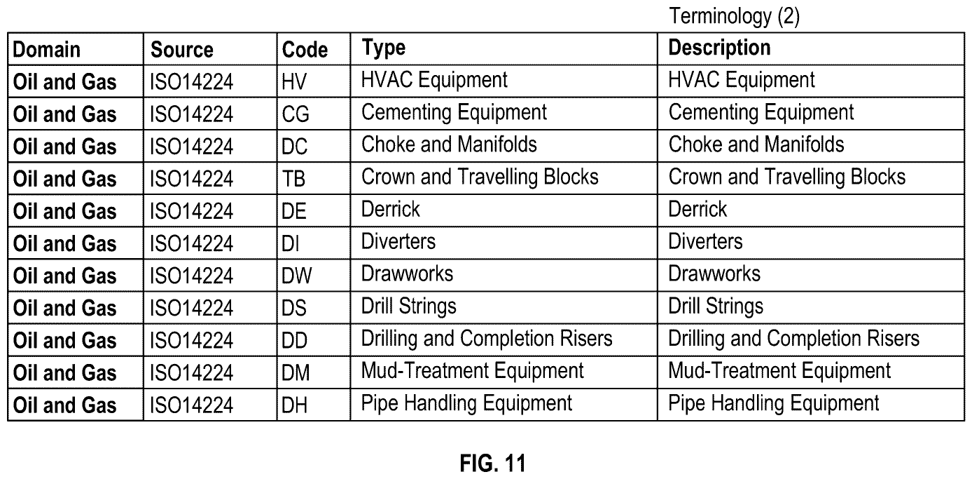

FIG. 11 is example acronyms and domain vocabularies, in accordance with some embodiments. In some embodiments, the DPA uses Domain Acronyms and Abbreviations. For example, specialized domains (e.g., oil & gas) may not comprise general knowledge, and thus would likely not be available to a generic LLM. The DPA may acquire meanings for these, either from user input, and/or by AI analysis of documents in the domain.

Token splitting approaches, among other concepts, are described as follows. In some embodiments, as the DPA extracts data from data sources, the DPA may encounter text it cannot understand, such as text that isn't designed for human (e.g., and thus LLM) consumption. The DPA may not be able to rely on punctuation, or even white space between words or identifiers to parse such data. In such examples, the DPA may look for the easy ways to split the text of a tag, for example by replacing any special characters in the text with a split character. This may comprise any special character, but may be represented as a space. In some embodiments, the DPA iterates across the text chunks split by spaces and check to see if they represent (e.g., in preferential order) any one or more of the following: a local identifier; a single character; a numeric; a known vocabulary word; a known acronym; a word; or the like. If any one or more of these conditions is met, the DPA may determine that the text cannot be further broken down. The DPA may determine the text is a “token”, and may add the text to the running list of “tokens” from the source text. The DPA may then continue processing other pieces of the source text. If none of the conditions are met, the DPA may attempt to split the text on something other than spaces. This may occur in any suitable way, such as use of a word segmentation technique that separates things expressed as compound words, or exhaustive search of substrings, which may be each matched against the above list.

Token classification approaches, among other concepts, are described as follows. Once the text of a tag has been processed into a list of tokens, the DPA may attempt to classify the tokens as either contributing to “type” or “identifier”. For example, if the tag text is “CentrifugalPump123A North West”, the DPA would likely get a list of tokens like [“centrifugal”, “pump”, “123”, “A”, “north”, “west”]. The basic question for the DPA analysis of the tag may comprise “what does this thing describe?” For example, the DPA may establish a TYPE of thing that is being described. The DPA may attempt to separate the tokens into those that help identify the type of the object to which the tag refers, and those that help identify an instance of that object. In the tokens above, “centrifugal” and “pump” describe what type of thing are described. For example, “123”, “A”, “north” and “west” may describe a particular instance of that type (in this case, one particular pump among many). To do this, the DPA may (e.g., heuristically or using LLM) analyze text or tags and/or determine any one or more of the following: numerics may be interpreted as identifiers, not types; single characters may be interpreted as identifiers, not types; tokens that match user-supplied local identifiers may be interpreted as identifiers; combinations of the same; or the like.

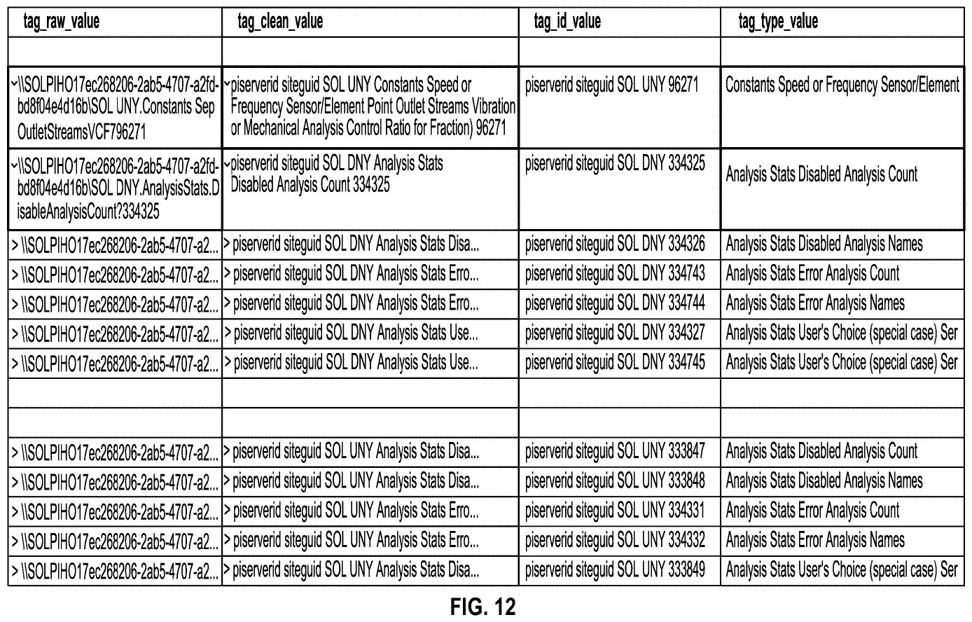

If the tag belongs to a Record or Structure that is part of a hierarchy (e.g., parent records, as in an XML file), then the DPA may access the hierarchy. The DPA may determine that tokens that appear in peer nodes in the hierarchy are likely to be Types, e.g., proportional to how many of the peers they appear in. The DPA may determine if the tag belongs to a Record that has a relationship to a Structure (e.g., a template, such as in XML, or a table for a row record). In some examples, the DPA may determine that tokens that appear in other records belonging to the same structure are likely to be Types proportional to how many peers they appear in. At the end of this process, the DPA may take the list of tokens and create two new lists, such as id_tokens, and type_tokens. Example tag data after tokenization and categorization, from an industrial asset model, are depicted in FIG. 12.

Multi-dimensional tokens, among other concepts, are described as follows. In some embodiments, special tags comprise additional structure beyond simple text. These may result in more complex (e.g., multi-dimensional) lists of tokens. For example, “pi_tag”, which are tags found in industrial time-series data, may be complex tokens. These may be structured like a URI, with slash-separated chunks. While it may be useful for the DPA to recompose these tokens looking for types/identifiers and expanding acronyms, etc., the original structure may be too valuable to lose. Accordingly, the DPA may end up with a two or more dimensional list of tokens.

Data (e.g., industrial data) augmentation, among other concepts, are described as follows. As described herein, industrial data may include time-series measurement of machine data, which may be identified by “pi_tag” identifiers. While these identifiers point to a specific instance of a data attribute, they may comprise data about the type of equipment they are measuring. Additionally or alternatively, identifiers may comprise hierarchy information. The slash-separated structure may identify a hierarchy which may refer to a user-driven view of how a plant is structured, or in other cases the hierarchical structure of the electrical controls attached to the equipment. In some embodiments, the structure is valuable to determine if a given Record is referring to a single piece of equipment, or alternately represents a logical part of equipment organization or analysis. The degree of “meta” records of this type of data may be high in some embodiments, and may represent noise for the process. In some examples, DPA may start with the entities themselves (e.g., equipment) and then later address aggregates, analysis, etc., on that equipment.

In some embodiments, the DPA retrieves the pi_tag “type” tokens for each Record Attribute in a Record. The DPA may determine that these tokens likely contain some common elements, starting with the most significant group (e.g., starting from the left). The DPA may now determine how much they have in common, and at which location in the slash-separated grouping they diverge. For example, consider a Record (Record A) with Attributes with tags (e.g., \\piserver01\process_1\pump_control\temp01, \\piserver01\process_1\pump_control\pressure01). In some examples, the DPA may determine that these pi_tags don't diverge until the very last group, and the “common” portion of the tags may be, e.g., \\piserver01\process_1\pump_control. In some examples, the DPA may use this information to look for “rollup nodes” among the Records. As used herein, rollup nodes (distinct from match rollup described below) may refer to summary records that aggregate data from other records, such as averages or totals. For example, consider a Record (Record B) with Attributes with these tags: e.g., \\piserver01\process_1\pump_control1\temp01, \\piserver01\process_1\pump_control2\temp01.

In some embodiments, the DPA compares “common token” tags for each Record, and look for pairs of Records where the common tokens of one are contained in the other. In such examples, the DPA may see that Record A contains the common elements of Record B, but not vice versa. Once identified, the DPA enumerates all the Record Attributes of Record B to see if the common portion of Record A exists in each of their pi_tag tokens. For example, the DPA may determine that, the record “attr” in Record B with tag \\piserver01\process_1\pump_control1\temp01, contains the common portion of Record A: \\piserver01\process_1\pump_control1.

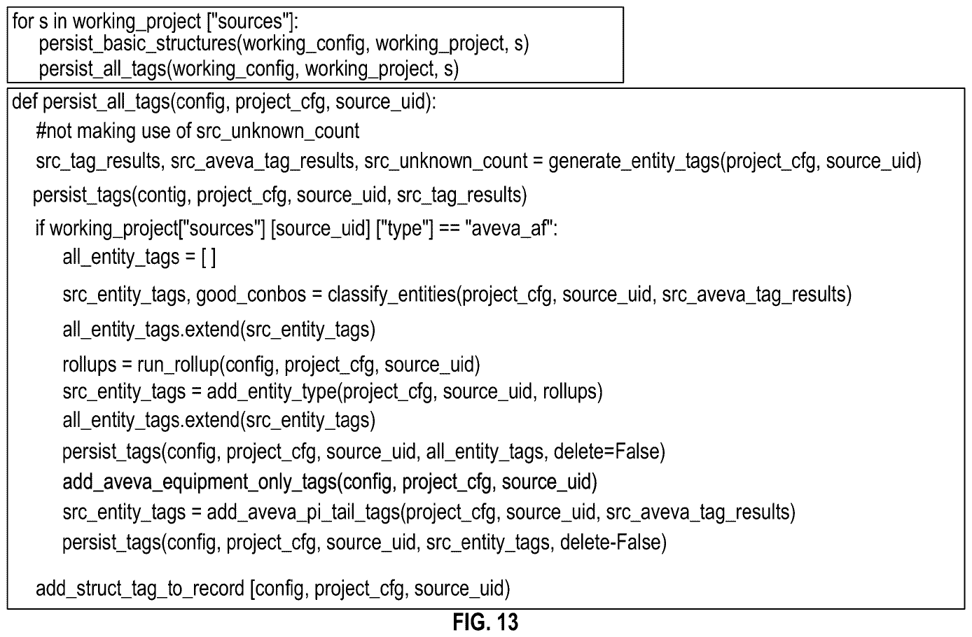

In some embodiments, for each pair of records (in this case A and B) the DPA counts the number of Record attribute (of B) that meet this criteria. By one measure, if this occurs more than 0 times, but less than 50% of the time, then the DPA may estimate that Record B is likely a “rollup” of Record A. With this estimate in hand, the DPA may attempt to categorize whether each Record represents a piece of equipment. For example, any Record that contains no pi_tag tags may be discarded, and/or any record that appears in the list of “rollups” generated above. Finally, any record that contains keywords indicating it might be an aggregate or rollup (e.g., “average”, “avg”, etc.) is discarded. The remaining records may have an additional “entity_type” tag added and be retained for the remainder of the processing. Example code that may be used to perform any of the approaches described in the above sections is depicted in FIG. 13.

Vectorization of metadata, among other concepts, are described as follows. In some examples, once tags have been augmented (e.g., acronym expansion, industrial entity classification, etc.) and/or classified (e.g., type vs id tokens), they may be prepared for semantic comparison (e.g., using LLM generated vectors). These vectors may be driven by a process commonly known as embedding (e.g., common practice in the emerging AI RAG workflow). For example tools include LlamaIndex and LangChain, which provides a framework for integrating retrieval, generation, and reasoning capabilities may be used. In some embodiments, embedding models convert text into high-dimensional vector representations that capture semantic meaning, enabling similarity comparisons between different text elements. Example embedding models that may be used include transformer-based embedding models, BERT-based models, or other neural network architectures for text embedding such as sentence-transformers. These models may generate vectors with hundreds or thousands of dimensions, where semantically similar text produces vectors that are closer together in the high-dimensional space. In some embodiments, the vector embeddings generated for each tag may have matching dimensionality (e.g., the same number of dimensions) to enable pairwise comparison between the vectors, as vectors of different dimensions cannot be directly compared using distance or similarity metrics.

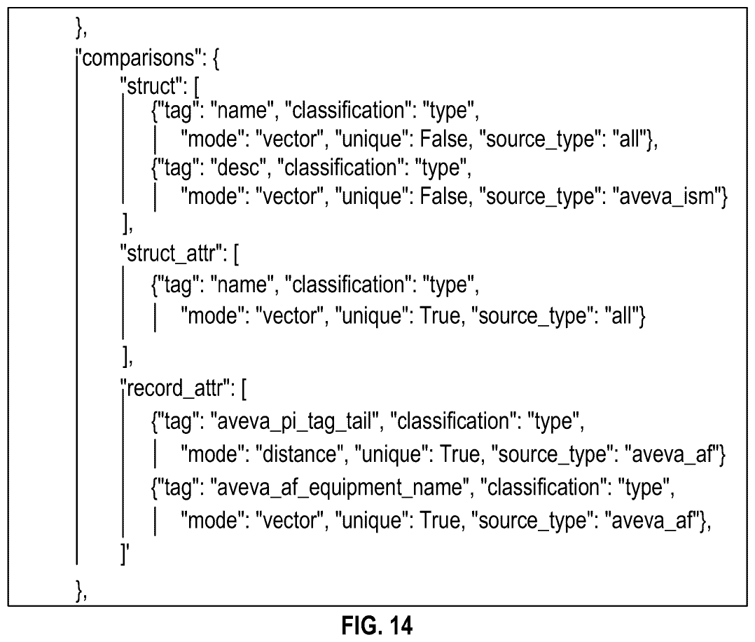

FIG. 14 is an example comparison configuration, in accordance with some embodiments of the disclosure. In some embodiments, not all tags may be suited to comparison with vectors, and then the DPA may instead utilize “edit distance” technique to compare the proximity of their strings. This may be useful for technically complex tags (e.g., in some cases PI tags) that despite augmentation may not be suitable for semantic comparison with vectors. The DPA may determine which tags are to be used to compare entities in the structural model as part of the process configuration. The tags may vary by entity type (i.e., structures vs records) or by data source type (i.e., industrial sources with special tags). An example configuration is depicted in FIG. 14.

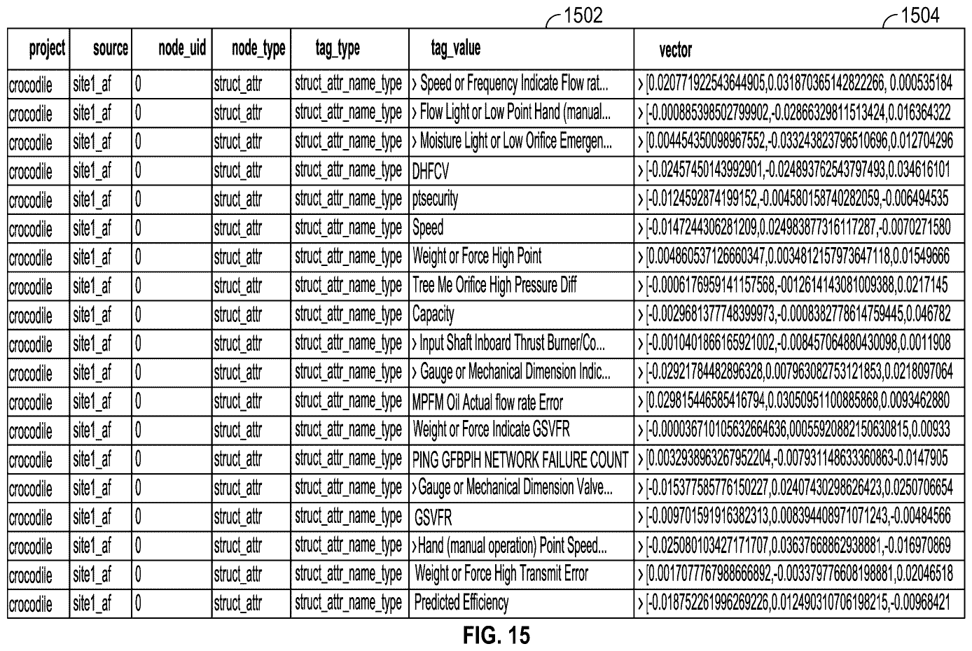

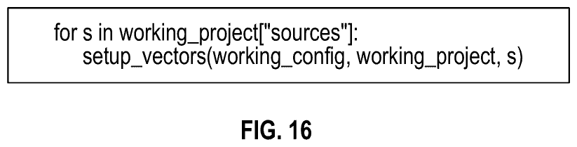

In some embodiments, the configuration may include “unique” attribute in the configuration. Since vectors are computationally expensive to generate (and even more expensive to compare in the steps to follow) the DPA may use an optimization by looking for unique values of each tag, and generating vectors for those. In some datasets, there is so much repetition of certain tags, that this may generate a multiple factor reduction in data follow that must be embedded and compared. Example tag values with vectors are depicted in FIG. 15 (e.g., in the tag_value column 1502 and vector column 1504). FIG. 16 depicts example code for vector generation, in accordance with some embodiments.

Match generation and aggregation, vector matching, among other concepts, are described as follows. In some embodiments, a “match” may be seen by the DPA a relationship between two nodes in the structural model (e.g., records, record attributes, etc.) based on the strength of similarity between their tags. Vector similarity search may be a common step in the AI RAG workflow. In advance of a query, data may be embedded (by the DPA), into vectors and stored in a special “vector store” database. At query time, the query may be embedded by the DPA with the same LLM, and a search may be run on the vector store (optimized for this purpose) to retrieve data records most closely matching the query. A “top_k” approach (e.g., to find best five matches) may be used. In this application, the vector search may be described as being one-to-many. In some approaches, one query is searched, by the DPA, across many data records.

In some embodiments (e.g., for purposes of ontology integration), the DPA builds a graph of match relationships between all the nodes in the structural model. To accomplish this, all records may be compared to all other records for match strength, for example. For example, if a data source contains records A, B, C, and D, the DPA may generate pairwise comparisons for each combination: A-B, A-C, A-D, B-C, B-D, and C-D. In this way, the pattern could be described as many-to-many, and as such requires much different technology than the RAG vector search pattern. In some embodiments, the DPA may use vector similarity techniques, such as cosine similarity, to compare tags. Alternatively, for tags that are not well-suited to vector comparison, the DPA may use edit distance techniques to compare the proximity of their string representations.

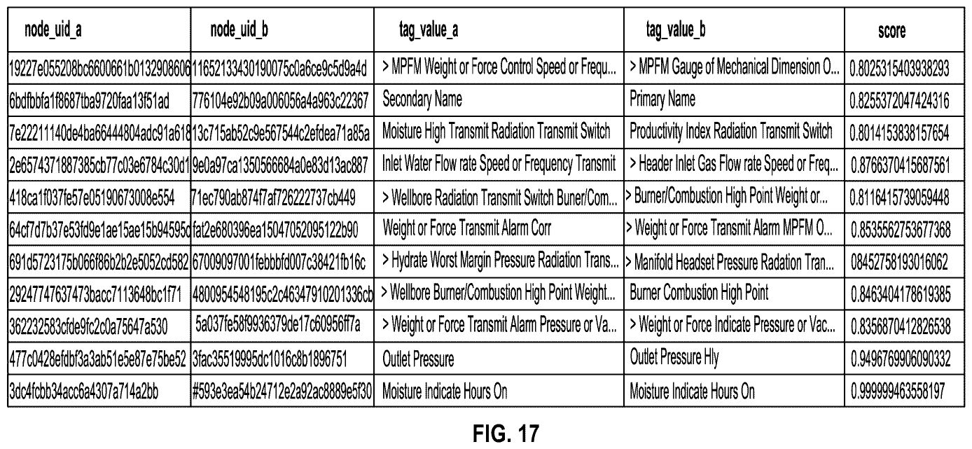

FIG. 17 is example match data, in accordance with some embodiments of the disclosure. In some implementations, Apache Spark is used by the DPA to access management technology for integrating data at scale. One skilled in the art will appreciate that other data management technologies (data warehouse, etc.) may also be used. Comparison of vectors is performed by the DPA by computing the distance between them in a high-dimensional cartesian space. This may require normalizing the vectors (e.g., refactoring them until they have the same direction, but length=1), and taking their dot product (e.g., taking the sum of the place-wise multiplication of each element in the vector pair). This may result in a number between 0.0 and 1.0, reflecting the cosine similarity of the vectors, and (e.g., via the science behind LLMs) thus their semantic similarity. To compare each node to all other nodes, the DPA may use a technique analogous (e.g., in SQL) to joining the list of nodes to itself by cartesian product. In some examples, this may be a computationally expensive operation.

To increase efficiency, the DPA may limit the comparison to the set of unique tag values (e.g., as described above). The DPA may also “pre-normalize” the vectors before comparison. In some examples, the DPA may use implemented the vector dot product as a SQL statement, involving aggregate operations on arrays, an advanced datatype in Spark SQL.

In some embodiments, after matches have been computed for all pairs of the unique values of tags, the DPA may apply this result to the original list of nodes, resulting in a much larger list of matches.

Match roll-up approaches, among other concepts, are described as follows. In the ontology integration process, the DPA may use matches between child entities to help determine the strength of matches between the parent entities. In some examples, the names of tables (e.g., structures) are non-descriptive, so to tell if two tables (e.g., structures) represent the same real world thing (e.g., the same class in the semantic model) it may be more effective to tell if they have similar columns. For example, in the industrial context, records may be poorly named such that relationships may only be established between them by comparing their attributes. In some examples, such as cases where we generate a match at a particular node type in the structural model, we may want to “roll up” those matches to a parent node type. Rollups may include Record Attribute to Record, Structure Attribute to Structure, Record Attribute to Structure, Record to Structure, or the like.

The match roll up techniques may be implemented as a SQL query. The process may include any one or more of the following steps: for each instance of the parent node type, the DPA connects to a list of the instances of the child node type to which it connects; the parent-to-child reference is joined to the list of matches between the children; the list of matches to the children is then joined to a second instance of the parent-to-child reference data; or the like. In this way, a list of all possible child-node matches between every pair of parent-nodes may be generated. In some examples, for each child-node instance, only the best match may be appropriate, so the DPA may process the list down to the best matches for each child node. If one parent node has more attributes, for example, some of them may get no match at all as the attribute from the other parent has already been “consumed” in the matching. The DPA may take the average strength of the child-node matches, and assign it to the parent-node pair.

For example, Record A may have Attr 1 and Attr 2, and Record B may have Attr 3, Attr 4 and Attr 5. For a given tag type, the following (exhaustive) matches exist: Attr 1 to Attr 3-0.8; Attr 1 to Attr 4-0.85; Attr 1 to Attr 5-0.75; Attr 2 to Attr 3-0.9; Attr 2 to Attr 4-0.85; Attr 2 to Attr 5-0.78. Starting with the strongest match, the DPA may establish that the match from Attr 2 to Attr 3 will be in the result set, and since Attr 2 and Attr 3 are now “consumed”, several other matches are off the table. For example, Attr 1 to Attr 3-0.8, Attr 2 to Attr 4-0.85, and/or Attr 2 to Attr 5-0.78 may be off the table, and Attr 2 to Attr 3-0.9 may be selected.

Continuing in the previous example, the DPA may moving onto the next best match, and may find Attr 1 to Attr 4. The matches to consider may comprise: Attr 2 to Attr 3-0.9; and/or Attr 1 to Attr 4-0.85. It also emerges at this point that Attr 5 may not be able to be matched in the context of Record A and Record B. (In this example the DPA is performing comparisons for every pair of records.) Since the two records have different numbers of attributes, the DPA may aggregate matches that will be different depending on the direction of the analysis. The DPA may take the minimum. (e.g., Pretending Attr 5 doesn't exist may cause a poorly high match). The Record Match may comprise the following equation: Record Match=(0.9+0.85)/3=0.583. The DPA may now add a match between Record A and Record B with strength 0.583.

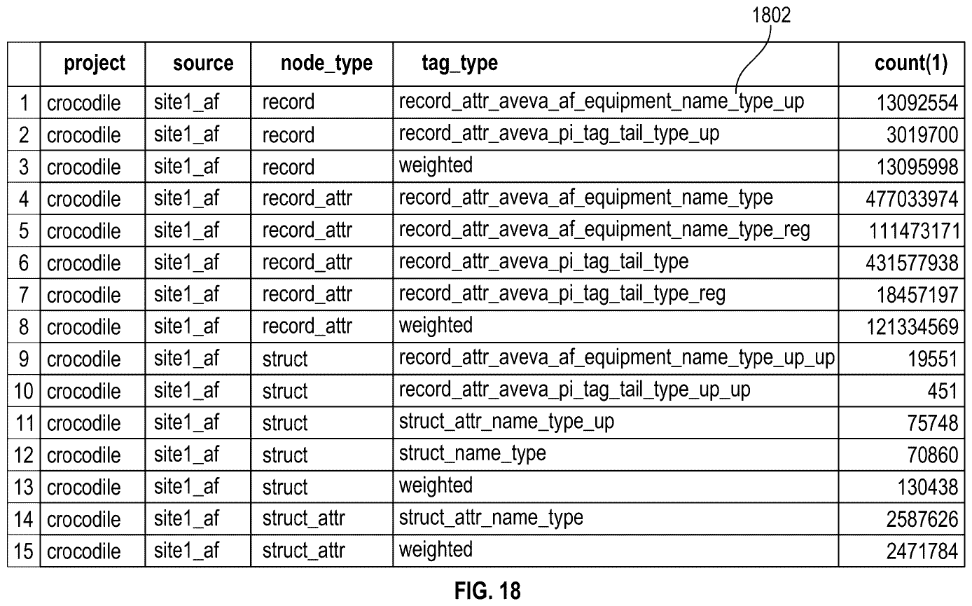

FIG. 18 is example match stats for an industrial asset model source, in accordance with some embodiments of the disclosure. As depicted in FIG. 18, matches that have been rolled-up from a lower level have their tag_type property suffixed with “_up”, such as 1802. Further, line 1 has been rolled up from line 4, with attendant reduction in the record count, and the node_type changes.

Match regulation, among other concepts, are described as follows. Match regulation (e.g., closely related to Match Roll-up above), processes performed by the DPA may remove matches between nodes that are not the “best” match between child-nodes of a pair of parent nodes. In some implementations, the SQL logic is the same except the final step of averaging the child-node matches and assigning it to the parent nodes. Instead, only the best match child-node matches may be retained.

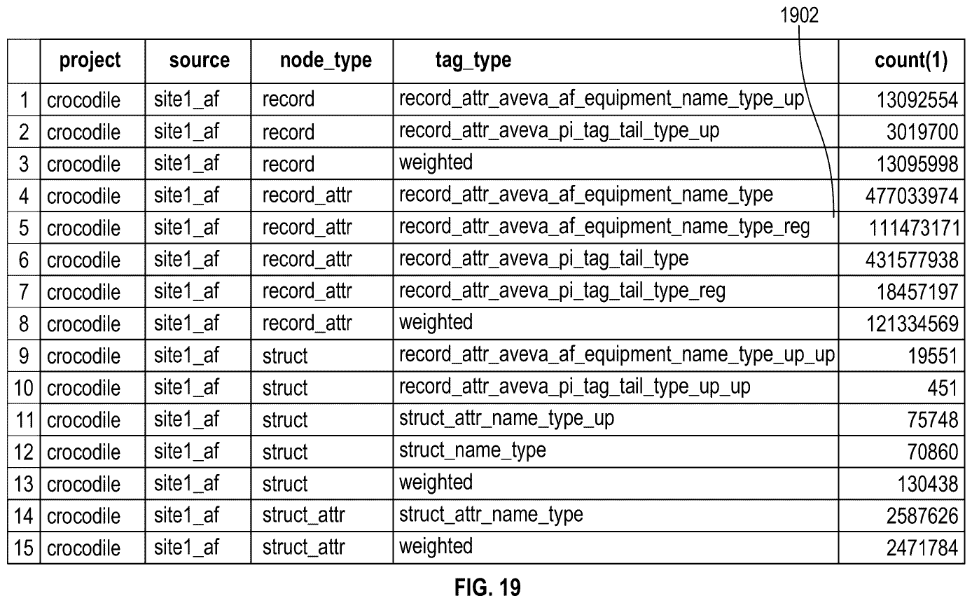

Retaining the previous example, the DPA may start with the matches: Attr 1 to Attr 3-0.8 Attr 1 to Attr 4-0.85 Attr 1 to Attr 5-0.75 Attr 2 to Attr 3-0.9 Attr 2 to Attr 4-0.85 Attr 2 to Attr 5-0.78. Doing the same analysis, the DPA may find that these two matches are the “best”: Attr 2 to Attr 3-0.9; and Attr 1 to Attr 4-0.85. The DPA may now create a new match at the Record Attribute level (e.g., with a new match type identifier) which contains only the two best matches, not the original five. FIG. 19 depicts match statistics from the same industrial asset model source. Regulated matches are suffixed with “_reg”, such as 1902. Further, as depicted in FIG. 19, line 5 regulates line 4, with attendant reduction in count, and the node_type stays the same.

Match aggregation, among other concepts, are described as follows. As different data sources may comprise additional special tags (and matches are computed for each tag type, at each node type) the DPA may now have a wide variety of match types comparing the same node types in the structural model. The DPA may now aggregate these matches into a single match type for every node type in the structural model. For example: “name” and “description” matches for structures may now be combined into a match type described as “weighted”. When aggregating matches, a constant weight is applied. (If two match types are combined, the values are added, then divided by two.) It may be possible to expose detailed configuration of this weighting to the user interface. For example, perhaps a user interface might be provided indicating that “name” matches may be weighted more strongly than “description” matches in further analysis.

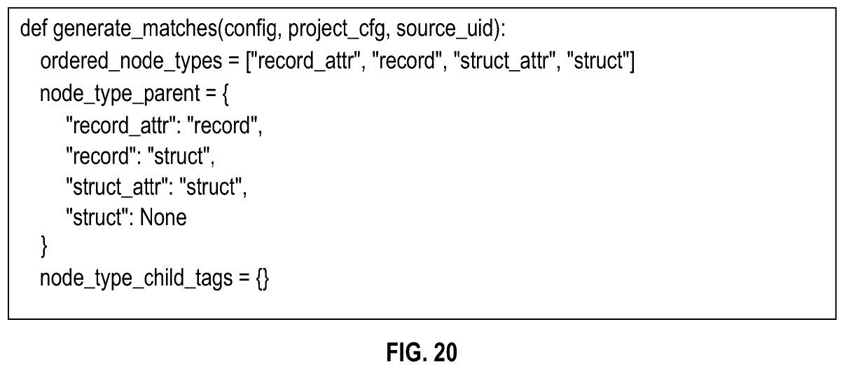

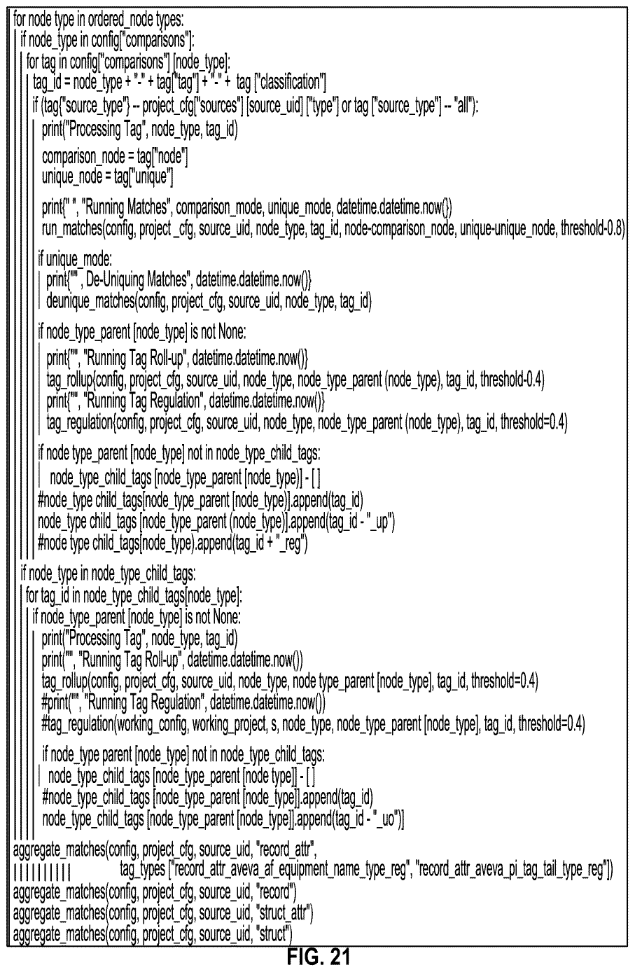

In some examples the strategy of using child node types (e.g., record attributes) to drive relationships between parents (e.g., structure, records) may be used. For this, the DPA may process different node types in an order that allows children to always be processed before parents in the structural model. FIG. 20 is example code for generating matches function using child node types, in accordance with some embodiments.

The DPA may loop over the node types (e.g., in order). The DPA may perform any one or more of the following steps: generate basic matches; rehydrate as necessary; run rollups as necessary; as this tag now belongs to a parent node type, the DPA may pass this information to the next iteration; run regulations as necessary; aggregate matches (e.g., generated “weighted” match type); combinations of the same; or the like. FIG. 21 is example code to perform any one or more of these operations, including aggregating matches.

Grouping and compression, among other concepts, are described as follows. The DPA may use the match strength between nodes in the structural model to group them into related communities. In some examples, this may work because nodes more closely related are more likely to represent the same thing. However, some relationships may be too close. In some embodiments, DPA is apt to figure out which instances of records, structures, etc., represent the same thing in the outputs semantic model. The DPA works to group nodes together into groups that coincide with what is timely useful, and that may cover different levels of abstraction and analysis. For example, the following represents a few Record nodes the DPA might find, and their “name” matches: Record A has name tag “Honda Civic”; Record B has name tag “Toyota Tundra”; and Record C has name tag “Sikorsky Sky Crane”. The matches are as follows: Record A to Record B-0.9 ; Record A to Record C-0.75; and Record B to Record C-0.8.

Continuing with the previous example, the DPA may encounter the problem of deciding how these records should be grouped. The best match is A to B, so the DPA may pick that pair and later name it “automobiles” in the resulting semantic model. In one example, a semantic class “vehicles” may be useful, in which case Records A, B, and C may all belong in the same group. In other examples, (e.g., for utility company) hatchback and a pickup truck may not be the same category, and there may be three groups, with one record each.

In some embodiments, the DPA uses “all of the above” approach and evaluates all possible suitable groupings (moderated by the match scores). The DPA may evaluate groups at multiple levels of “confidence” (e.g., a measure of match proximity as described above). For example, if Record A matches Record B with a cosine similarity score of 0.9, and Record A matches Record C with a score of 0.75, the match strength between A and B is higher than between A and C. The DPA may use vector similarity techniques to compute these scores by normalizing the vectors and taking their dot product, resulting in a value between 0.0 and 1.0 that reflects semantic similarity. In one approach the DPA may produce the following list: confidence_levels: [40, 50, 60, 70, 80, 90, 95, 97, 98, 99, 99.5, 99.6, 99.7, 99.8, 99.9, 100].

In some embodiments, the process of the DPA may comprise any one or more of the following steps: the DPA loops through this list described above, and for each value, retrieves the list of matches available; the DPA forms the matches (which each connect two nodes in the structural modal) into a graph; the graph may contain only those edges where the match strength exceeds the currently selected confidence level; the DPA runs a “connected communities” algorithm (e.g., or another suitable algorithm) on the graph, which lists for all the “islands” within the graph, that it is impossible to move between given the available edges; and/or the DPA record each of these groups.

Continuing with the above example, at confidence=0.40, the DPA may obtain one group, and the same would be true at every level up to 0.8. Similarly, after 0.90, every level gives three completely groups, with one record each. The DPA may remove and/or compress out redundancy by rejecting (e.g., marking as duplicate) all groupings where there exists an identical grouping with a higher confidence level. For the example above, the final group of (e.g., unique) groups may comprise any one or more of the following: Group 1: Level 0.7, Members: A, B, C; Group 2: Level 0.8, Members: A, B; Group 3: Level 1.0, Members: C; Group 4: Level 1.0, Members: A; and/or Group 5: Level 1.0, Members: B.

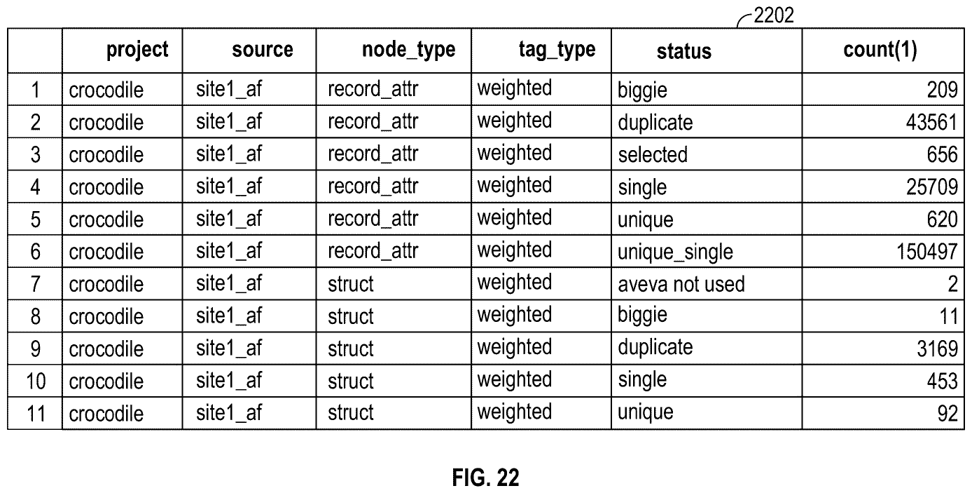

FIG. 22 depicts an example group statistics, in accordance with some embodiments of the disclosure. The status column identifying duplicates as described herein comprises column 2202. In some implementation, the DPA is also differentiating excessively large and excessively small (e.g., singleton) groups.

The grouping described above may performed across an entire population of nodes from the structural model, typically per data source. However, it may also be useful to generate groups on a set of nodes constrained by their relationship to another group. As a concrete example, after the DPA generate a list of groups of structures, the DPA will want to do the same for structure attributes. But, instead of simply finding groups among all structure attributes, the DPA may generate it for each structure, and make groups out of only those structure attributes which are children of that particular structure in the structural model.

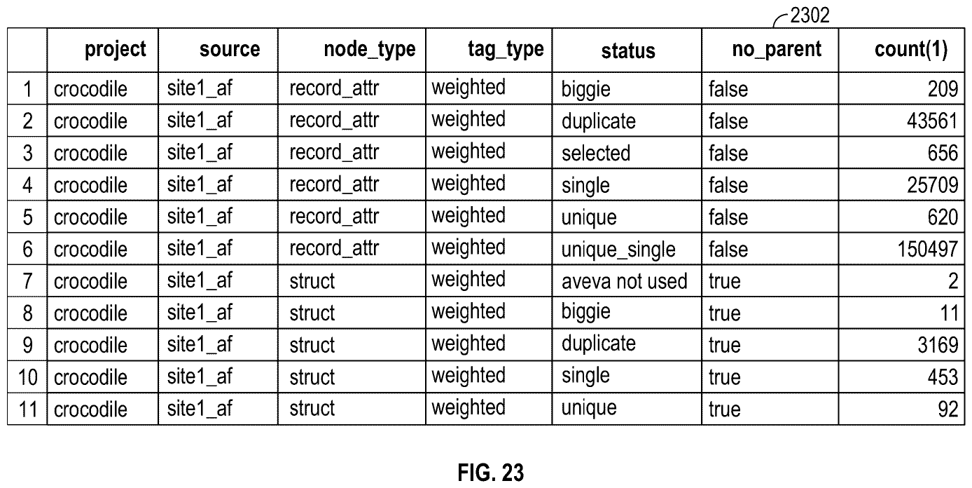

FIG. 23 is example no parent data, in accordance with some embodiments of the disclosure. In some examples, the result of group regulation may be connected (e.g., grouped or matched) child nodes in the context of some parent node. As depicted in FIG. 23, example data is provided, but with “no_parent” data (e.g., column 2303), indicating whether the groups have been generated on the full population, or in the context of a parent. Note that all the structure groups are on the total population, while record_attr (e.g., which roll up to structures) have been generated with a parent (e.g., a structure) as context.

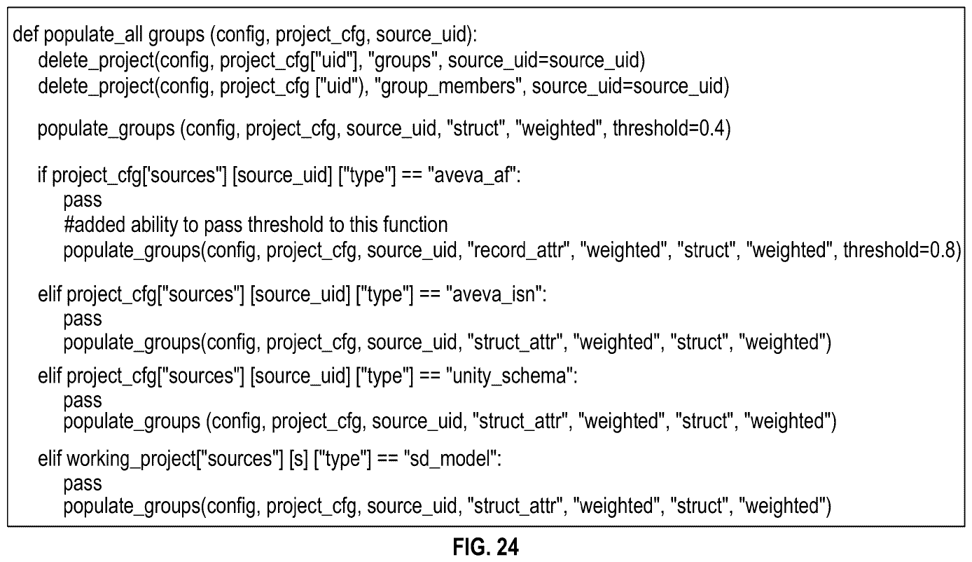

Regulated group coverage optimization, among other concepts, are described as follows. FIG. 24 is example code for group regulation, in accordance with some embodiments of the disclosure. As described herein, techniques to picking the correct confidence level for groups may include taking a wide range, eliminating redundancy and triviality, and/or passing one or more decisions on to the user interface for user input. However, in the case of Regulated Groups (e.g., groups generated in the context of a parent group), there may be another suitable approach. In some examples, regulated groups may be attributes (e.g., structure attributes or record attributes) which make up the substance of a parent structure based group. In such examples, if the parent structures truly represent semantic classes of the same type, then the DPA may expect that their attribute would be evenly distributed across instances belonging to the group. Thus, there may be an optimum confidence level for the regulated groups, such that each regulated group for a given parent group has a similar population.

In some embodiments, one or more steps may implement an additional strategy. In some embodiments, for every data source, the DPA may always generate structure groups first. Then, depending on the type of data source, the DPA may generate either record attribute or structure attribute groups in the context of the parent structure groups. Such techniques may be implemented by the code depicted in FIG. 24.

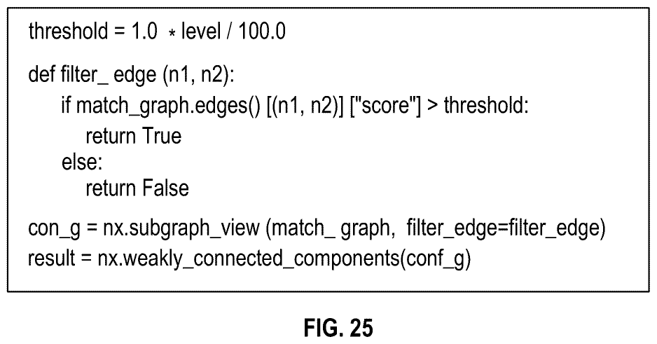

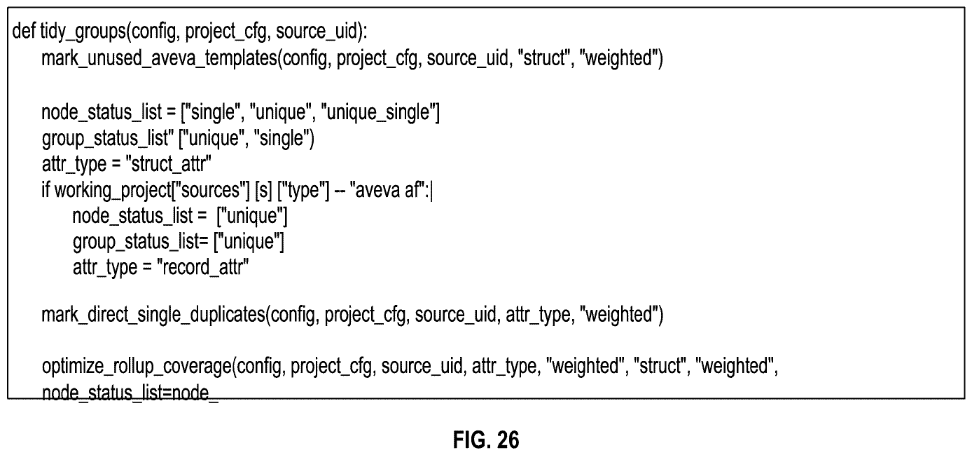

FIG. 25 is example code to limit the graph to edges meeting the confidence level, and extracting connected groups. Further, in some examples the DPA may run optimization of the rollup coverage of the structure attribute or record attribute regulated groups. Such techniques may be implemented by the example code of FIG. 26.

Semantic fragment alignment, among other concepts, are described as follows. As described herein, structures may not be 1:1 with model concepts. A table may contain information about a Person, but may not completely overlap with another table fundamentally describing the Person. In some embodiments, the DPA may map tables and/or structures to group with higher precision (e.g., tables with high column overlap) while other tables about the same concept but without such a large overlap might not come into play until a lower confidence level is tried. Further, the DPA may implement or add another Fragments layer between structures, records, attributes, groups, combinations of the same, or the like. The DPA may take all combinations of structures, for example, and see how the combinations match to other structures. For example, while Table A and Table B might be a poor match to Table C, perhaps Table A and Table B together (e.g., combined as a fragment) are a match to Table C.

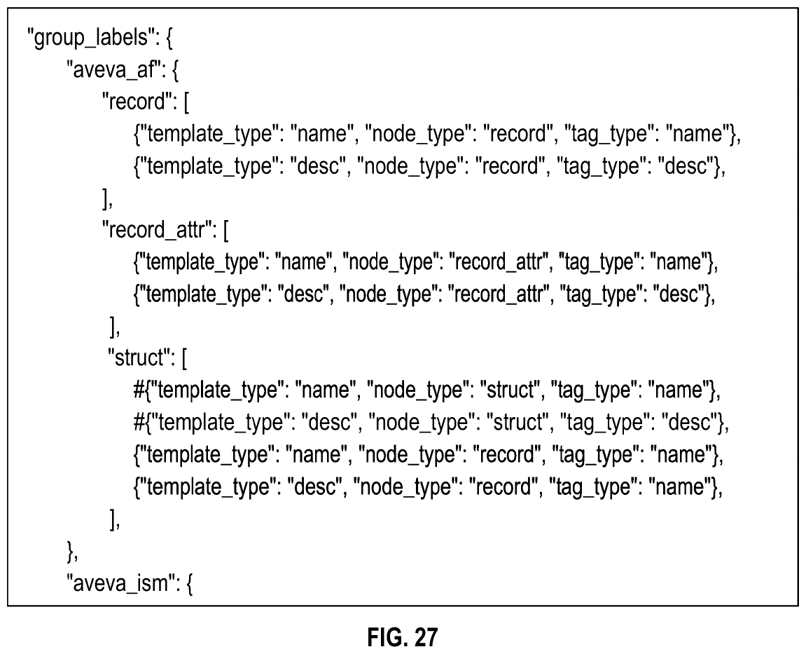

FIG. 27 depicts example group labeling, in accordance with some embodiments of the disclosure. The DPA may comprise groupings of structural modal nodes (e.g., particularly, but not necessarily structures) that might make good classes in the final resulting semantic model. The DPA may give each group a readable name. For example, the DPA may pass the values of tags for each member of a group to an LLM, with a prompt asking it to summarize the metadata into a good class name. The tags that are considered for group naming may be outlined in the process configuration, and may not need to be the same tags used for the earlier matching comparison of nodes.

Class hierarchy, among other concepts, are described as follows. As described in the vehicle example above, some potentially useful groups overlap each other. In the case where one group (Group A) is completely contained by the members of another group (Group B), the DPA may interpret this as a subclass relationship. I.e., Group A is a subclass of Group B. Using this analysis, the DPA can create a graph of a potential semantic model with connected (via subclass edges) classes. But, in some embodiments, if there was a third Group C which is completely overlapped by Group A, the DPA could expand the relationships to: Group A is a subclass of Group B; Group C is a subclass of Group A; and Group C is a subclass of Group B. All three relationships may exist, but if C is a subclass of A, the additional edge to Group B may cause additional difficulty in model interpretation. The DPA may establish a “meta” node at the top of the graph, as a parent to all other nodes that are not subclasses otherwise. The DPA may then run a “longest path” algorithm to find the longest path from every node to the new top “meta” node. This may simplifies the concept hierarchy to, for example: Group A is a subclass of Group B; and Group C is a subclass of Group A.

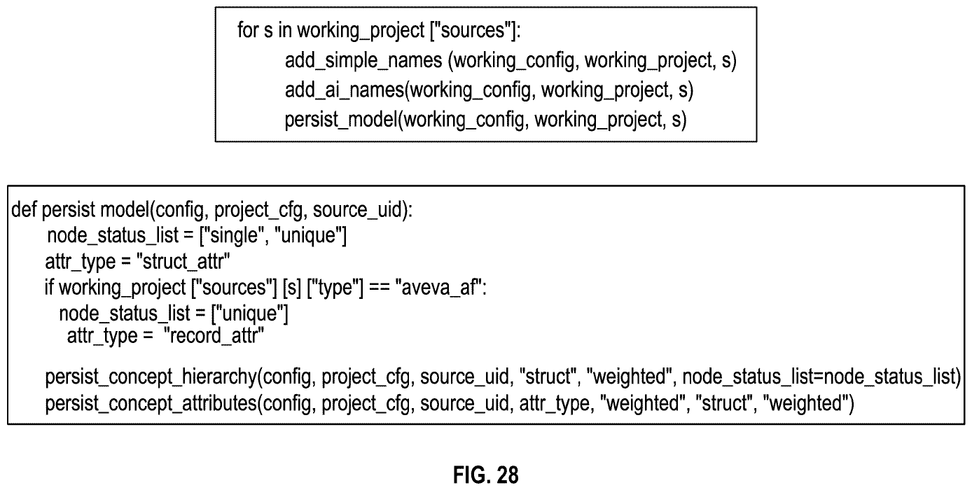

FIG. 28 is example code to generate hierarchy of groups. The DPA may now be in possession of structure groups (e.g., which are potential classes in a semantic model) and their attribute groups. The DPA may now generate a hierarchy of groups using any of the code depicted in FIG. 28.

In some embodiments, there may be one or more steps that can introduce redundancy or ambiguity. For this reason, it may be desirable to allow for user interface input that provides for an efficient mechanism to resolve (or verify) model configurations made automatically before the output is finalized.

Despite careful prompt engineering, responses from LLMs may be unpredictable. In some embodiments, appropriate names for classes must be concise. Accordingly, an opportunity for a user interface input to override selections made automatically may be used in any of the processes described herein. The user interface of the DPA may generate for display details about the membership of prospective class (i.e., which records, attributes, tags, etc. it is connected to), and generate for display an input field that allows for an override of the AI generated name.

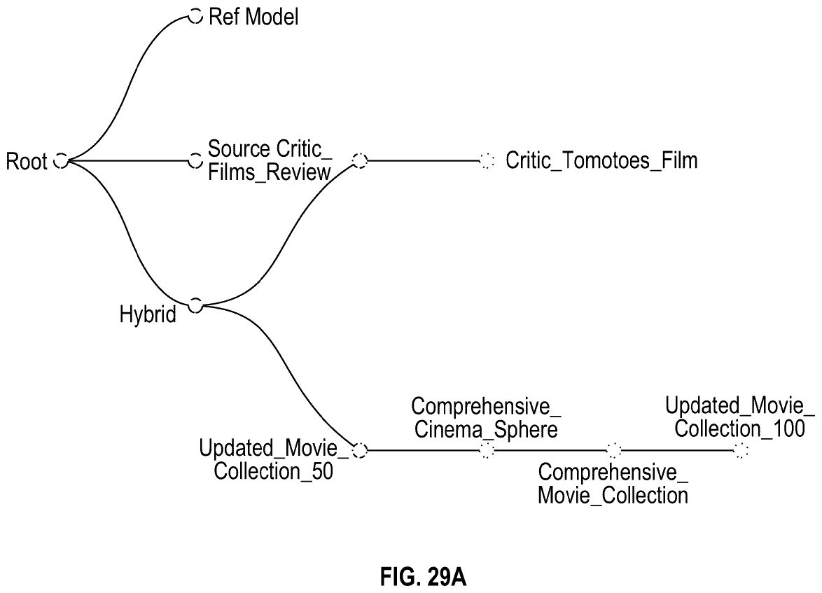

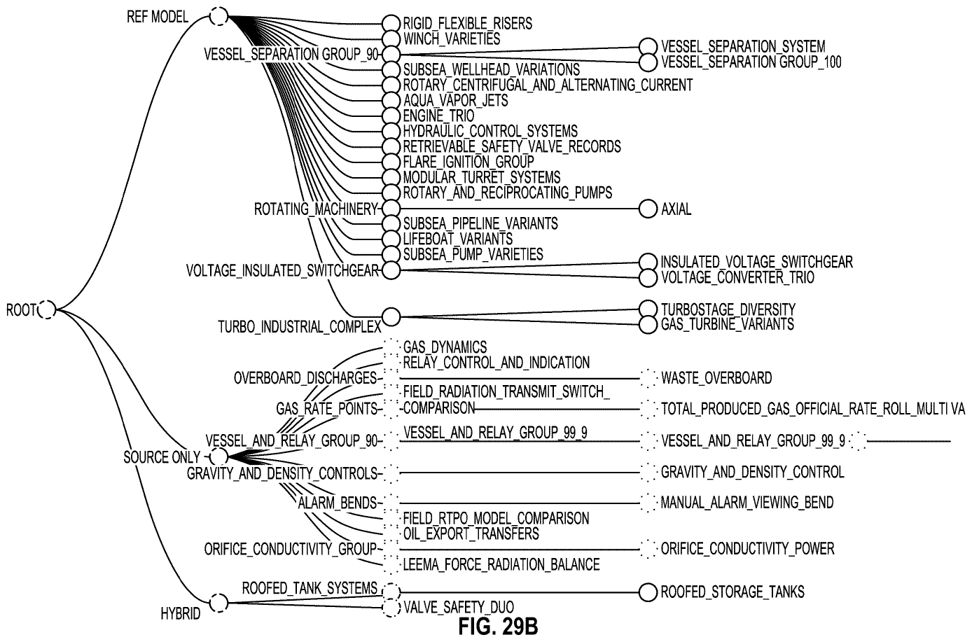

Example UI interface for “movies” database use case is provided in FIG. 29A. An example interface for industrial asset model is provided in FIG. 29B. For example, a user may click on any node and cut out certain group interpretations which will then collapse/compress the model. In another example, a user can click and edit any name of any node. The user may also modify confidence levels for group selection.

During compression across confidence levels, the DPA may end up with one or more of: subclasses that vary only trivially from their parent classes; an excessive depth of subclass relationships, making the model ultimately harder for users to navigate due to an over-abundance of choice; and/or, excessively tightly focused classes (“mid-size red cars”, where maybe “cars” is all the specificity needed).

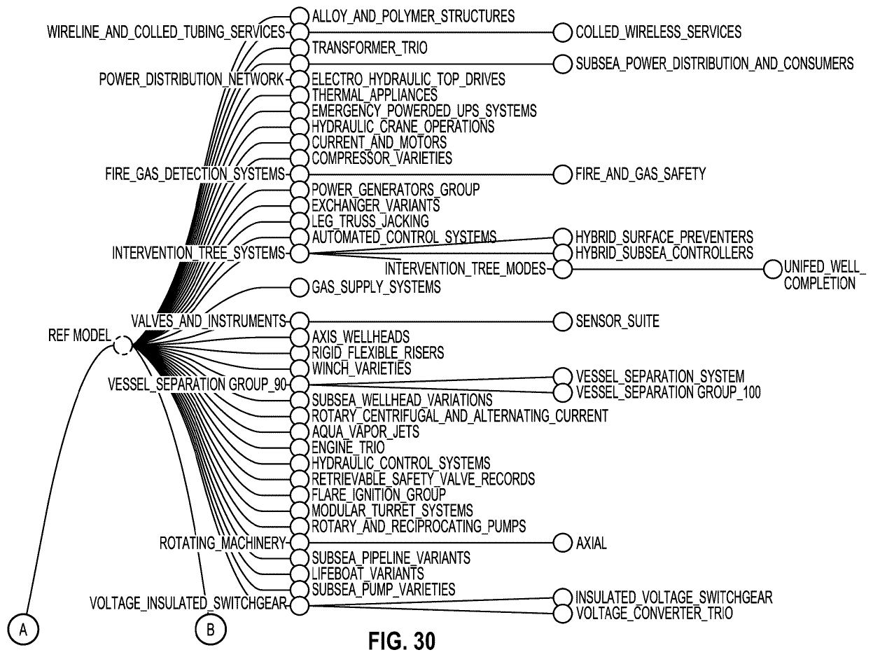

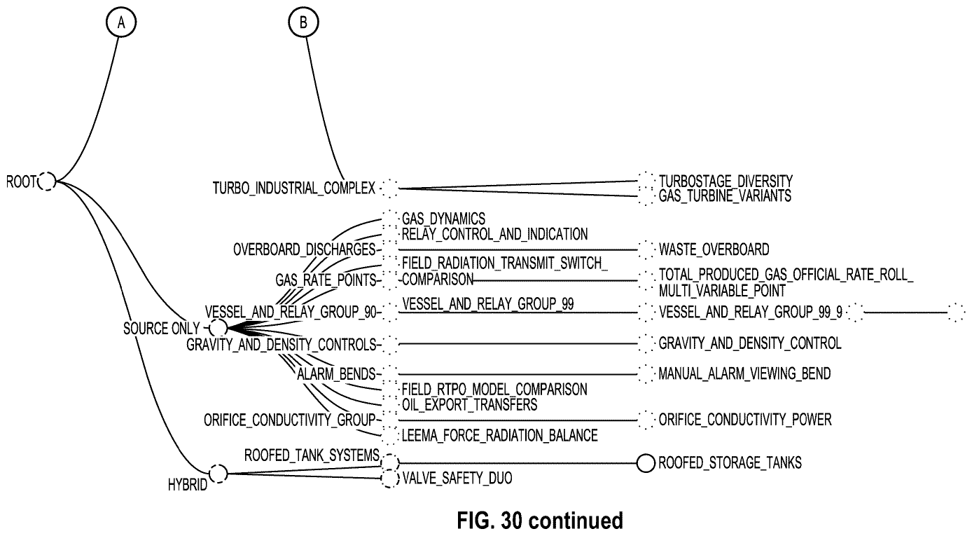

FIG. 30 is an example user interface, in accordance with some embodiments of the disclosure. As depicted in FIG. 30, the UI of the DPA may provide the user with a hierarchical view of the model, showing all possible subclass relationships. The user may view stats on each class, such as stats that help differentiate each class from its parent, peers and/or children. User may be provided with a single user input (e.g., button) or another UI element to remove the class from the model. This then assigns any children to the parent class, effectively carving out a layer.

The workflow described herein may need to be run multiple times, such as when missing configurations are added, new reference models are added, and/or data sources change over time. For such reasons, any feedback via the user interface gives in the process may durable across runs. To achieve this, the DPA may use an identifier-generator for objects (structures, records, attributes, groups, concepts, etc.) which may be deterministic in nature. For example, regardless of the name AI ultimately gives a group, the DPA may identify that group based on a string generated by hashing the identifiers of the members of the group. (These members have been generated based on naming in the original data source.) So, if the user interface indicates that a particular group/class should be omitted from the model, that decision may be respected on subsequent workflow runs, even if the (e.g., non-deterministic) AI naming of the group/class changes.

The final model (e.g., with a hierarchy of named classes and attributes) may be exported to one or more of: a knowledge graph; a standards based ontology file like OWL; an application using a built-in modeling capability like BRANDA Connect; combinations of the same, or the like.

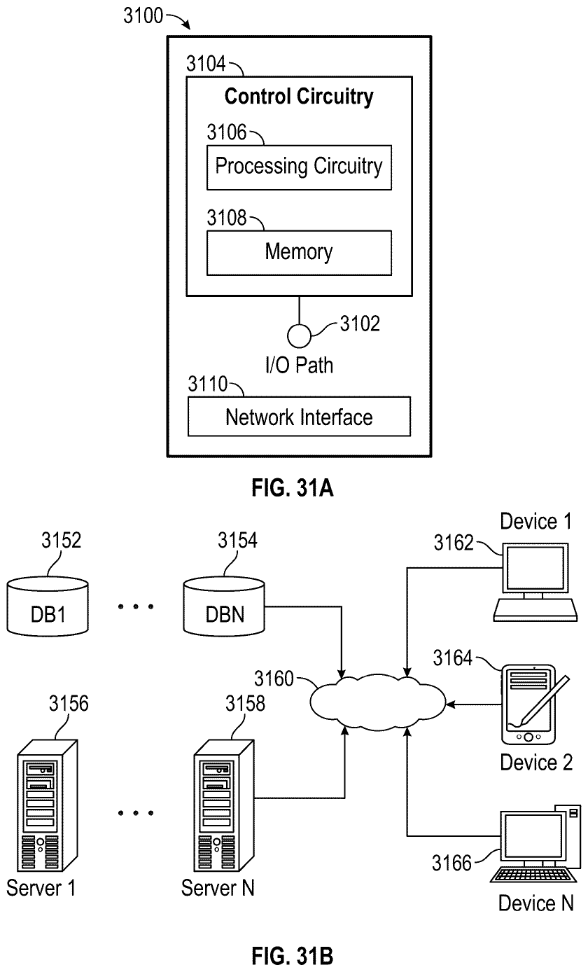

FIG. 31A shows a generalized embodiment of a device usable to provide data processing and visualization as described above and below. In particular, device 3100 of FIG. 31 may be any of the devices that perform steps described in FIGS. 1-30. Device 3100 may receive data via data network interfaces 3110 and provide the received data to control circuitry 3104 via an input/output (I/O) path 3102. In some embodiments, I/O path 3102 may comprise I/O circuitry. For example, I/O circuitry may comprise input/output controllers, bus interfaces, serial or parallel communication interfaces, display controllers, or the like. Control circuitry 3104 includes processing circuitry 3106 and storage 3108. Storage 3108 may include volatile memory 3130 (such as random-access memory (RAM), for example, static RAM and/or dynamic RAM), which does not retain its contents when power is turned off, and non-volatile memory 3108 (such as, for example, a solid state drive (SSD), a hard disk drive (HDD), electrically erasable programmable read-only memory (EEPROM), etc.), which does retain its contents when power is turned off. Control circuitry 3104 may send and receive commands, requests, and other suitable data using I/O path 3102. As noted above, I/O path 3102 connects control circuitry 3104 (and specifically processing circuitry 3106) to network interface 3110, which in turn connects device 3100 to one or more other devices. For example, I/O path 3102 may be used by one or more servers to received local or remote user interface input and provide visualization output to remote devices.

Control circuitry 3104 may be based on any suitable processing circuitry, such as processing circuitry 3106. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, octa-core, or any suitable number of cores). In some embodiments, processing circuitry is distributed across multiple separate processors or processing units, for example, multiple of the same type of processing units (e.g., two INTEL CORE i7 processors) or multiple different processors (e.g., an INTEL CORE i5 processor and an INTEL CORE i7 processor). In some embodiments, control circuitry 3104 executes instructions suitable to implement any of the techniques described above or below.

Storage 3108 may be an electronic storage device that is part of control circuitry 3104. As referred to herein, the phrase “electronic storage device” or “storage device” should be understood to mean any device for storing electronic data, computer software, instructions, and/or firmware, such as RAM, content-addressable memory (CAM), hard disk drives (HDDs), optical drives, solid state devices (SSDs), quantum storage devices, or any other suitable fixed or removable storage devices, and/or any combination of the same. The circuitry described herein may execute instructions included in software running on one or more general purpose or specialized processors. In some embodiments, storage 3108 may include a set of instruction, that when executed by control circuitry 3104 result in execution and operation of the DPA as described by FIGS. 1-30. In some embodiments, device 3100 mat comprise user interface circuitry for receiving user input (e.g., via keyboard, mouse, touch screen or any other suitable user input device). user interface circuitry may provide input data to control circuitry 3104.

FIG. 31B shows a diagram of an illustrative system 3150 for performing data analysis and user interface presentation, in accordance with embodiments described in FIGS. 1-30. For example, system 3150 includes any number of servers 3156-3158 that may be configured to perform all aspects of the DPA as described as above and below. For example, the DPA may be executed by any of the servers 3156-3158 or by a combination of servers using suitable distributed computing techniques. Servers 3156-3158 may be communicatively connected to any number of databases 3152-3154 by local connection or via network 3160. Network 3160 may be any kind of a suitable network, such as Internet, intranet, private network, virtual network, cellular network, or any combination the above.

System 3150 may include any number of client devices 3162-3166 (e.g., PCs, computers, smartphones, laptops, PDA or any other suitable computer devices). Client devices 3162-3166 may be configured to interface with servers 3156-3158 via network 3160. Client devices 3162-3166 may be configured to provide UI input to servers 3156-3158, e.g., to define the semantic overlay data structure for traditional data sources (e.g., stored on Databases 3152-3154). Client devices 3162-3166 may be configured to provide query input to the DPA executing on servers 3156-3158. Client devices 3162-3166 may be configured to received output provided the DPA executing on servers 3156-3158. For example, client devices 3162-3166 may display visualizations and query results provided the DPA generated for display by servers 3156-3158 via network 3160. Each of devices 3162-3166, 3156-3158, and 3152-3154 may comprise hardware as shown by FIG. 31A and/or any other suitable hardware.

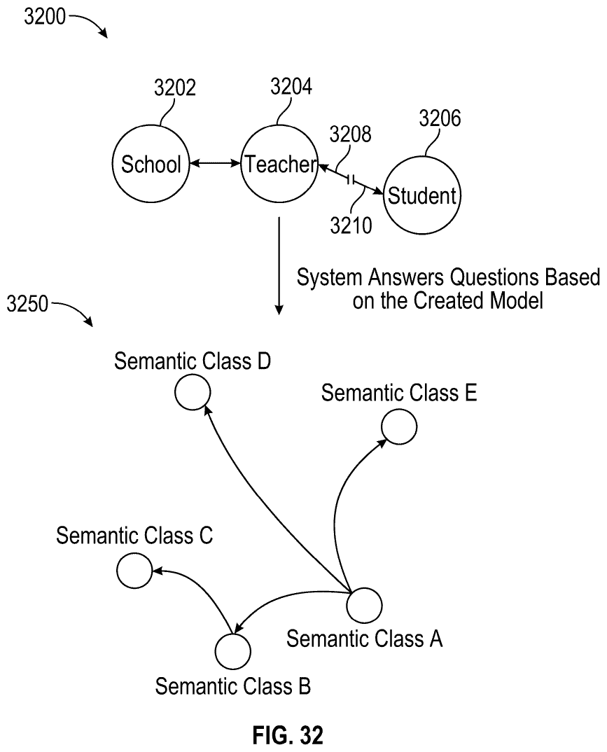

FIG. 32 shows an example use for the model once it's exported by the DPA. The DPA generates a semantic model 3250 with sematic classes and features for those classes (another example is shown in FIG. 1)

The system creates a sub graphs 3200 which may be used may a user to query the model. For example, the graph 3200 includes concepts School 3202, concept teacher, and concept Student (which may include features Name and Student ID.” Connections 3208 may also be shown. The graph subgraph shows the user that the query was correctly interpreted and thus that the system is on the right track and is considering correct data sources. The system may use the semantic model that was exported by the DPA to answer the question. In some embodiments, the graph subgraph may show trouble shooting data, e.g., as described in U.S. Pat. No. 12,079,212.

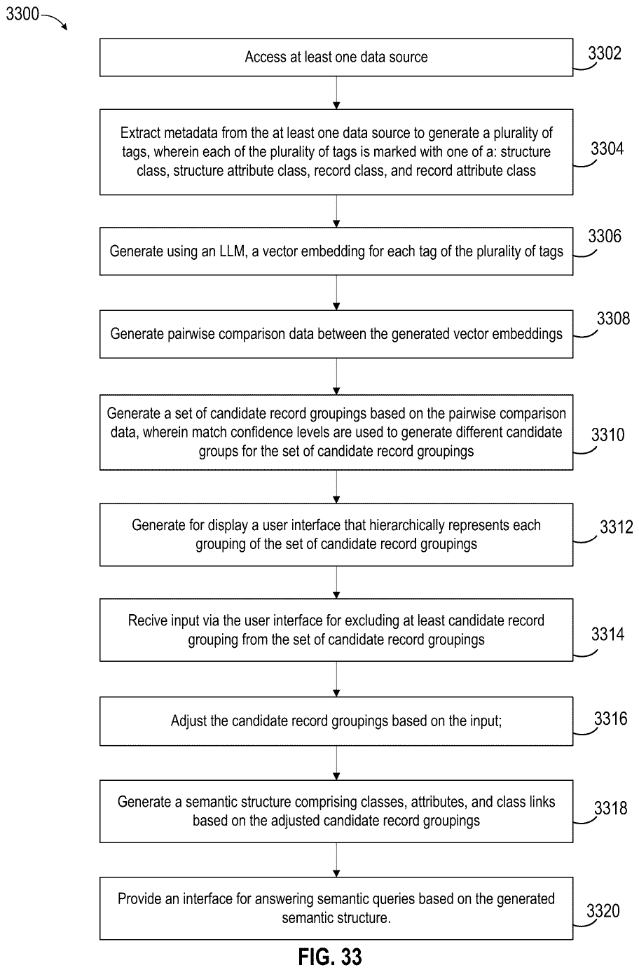

FIG. 33 depicts an example flowchart of a method 3300 for automated model generation, in accordance with some embodiments of the disclosure. In some embodiments, method 3300 may be performed by control circuitry 3104 of device 3100 (e.g., as shown in FIG. 31A). Control circuitry 3104 may include processing circuitry 3106 and storage 3108, and may communicate with external devices via I/O path 3102 and network interface 3110. For example, method 3300 may be performed by a data processing application (DPA) as described herein.

At step 3302, control circuitry may access at least one data source via I/O path 3102 and network interface 3110. For example, control circuitry may access data source 202 as shown in FIG. 2. The data source may include private databases or other non-public data sources accessible via network interface 3110.

At step 3304, control circuitry may extract metadata from the at least one data source to generate a plurality of tags, which may be stored in storage 3108. Each of the plurality of tags may be marked with one of a: structure class, structure attribute class, record class, and record attribute class. For example, control circuitry may generate structures as shown in FIG. 4, structure attributes as shown in FIG. 5, records as shown in FIG. 6, and record attributes as shown in FIG. 7. The structural model hierarchy is depicted in FIG. 3A, and example tags are shown in FIG. 8.

At step 3306, control circuitry (e.g., processing circuitry 3106) may generate, using an LLM, a vector embedding for each tag of the plurality of tags. For example, control circuitry may generate vector embeddings as depicted in FIG. 15 (e.g., tag values with vectors in columns 1502 and 1504). Example code for vector generation is shown in FIG. 16.

At step 3308, control circuitry may generate pairwise comparison data between the generated vector embeddings, which may be stored in storage 3108. For example, control circuitry may compare each node to all other nodes to generate match data as depicted in FIG. 17.

At step 3310, control circuitry may generate a set of candidate record groupings based on the pairwise comparison data, which may be stored in storage 3108. Match confidence levels may be used to generate different candidate groups for the set of candidate record groupings. For example, control circuitry may generate group statistics as depicted in FIG. 22.

At step 3312, control circuitry may generate for display, via I/O path 3102, a user interface that hierarchically represents each grouping of the set of candidate record groupings. For example, control circuitry may generate user interfaces as depicted in FIGS. 29A-29B and FIG. 30.

At step 3314, control circuitry may receive input, via I/O path 3102, via the user interface for excluding at least one candidate record grouping from the set of candidate record groupings. For example, as depicted in FIG. 30, a user may click on any node and cut out certain group interpretations.

At step 3316, control circuitry may adjust the candidate record groupings based on the input. For example, control circuitry may collapse or compress the model based on the user input.

At step 3318, control circuitry may generate a semantic structure comprising classes, attributes, and class links based on the adjusted candidate record groupings, which may be stored in storage 3108. For example, control circuitry may generate semantic model 3250 as depicted in FIG. 32.

At step 3320, control circuitry may provide, via I/O path 3102 and network interface 3110, an interface for answering semantic queries based on the generated semantic structure. For example, control circuitry may generate sub graphs 3200 as depicted in FIG. 32, which may be used by a user to query the model.

What is claimed is:

1. A method comprising:
accessing at least one data source;
extracting metadata from the at least one data source to generate a plurality of tags, wherein each of the plurality of tags is marked with one of a: structure class, structure attribute class, record class, and record attribute class;
generating, using an LLM, a vector embedding for each tag of the plurality of tags;
generating pairwise comparison data between the generated vector embeddings;
generating a set of candidate record groupings based on the pairwise comparison data, wherein match confidence levels are used to generate different candidate groups for the set of candidate record groupings;
generating for display a user interface that hierarchically represents each grouping of the set of candidate record groupings;
receiving input via the user interface for excluding at least one candidate record grouping from the set of candidate record groupings;
adjusting the candidate record groupings based on the input;
generating a semantic structure comprising classes, attributes, and class links based on the adjusted candidate record groupings; and
providing an interface for answering semantic queries based on the generated semantic structure.

2. The method of claim 1, wherein generating the plurality of tags is based at least in part on receiving a second input via the user interface of local identifiers.

3. The method of claim 2, wherein generating the plurality of tags is based at least in part on:
splitting text corresponding to the at least one data source to generate a plurality of tokens;
analyzing each token of the plurality of tokens to determine at least one of: a local identifier; a single character, a numeric, a known vocabulary word, or a known acronym.

4. The method of claim 1, further comprising:
analyzing each tag of the plurality of tags to determine the unique attribute; and
wherein the generating the vector embedding for each tag of the plurality of tags is based at least in part on the unique attribute of the respective tag.

5. The method of claim 1, further comprising:
generating, using the LLM, a name for each grouping of the set of candidate record groupings based on tag values of members of the respective grouping.

6. The method of claim 1, further comprising:
rolling up metadata from tags at a first level in a hierarchy to tags at a second level in the hierarchy prior to generating the set of candidate record groupings, wherein the second level is a parent level of the first level.

7. The method of claim 1, wherein generating the pairwise comparison data comprises comparing the vector embeddings using cosine similarity.

8. The method of claim 1, wherein adjusting the candidate record groupings comprises assigning children of the excluded candidate record grouping to a parent of the excluded candidate record grouping.

9. The method of claim 1, further comprising: exporting the semantic structure to at least one of: a knowledge graph or an ontology file.

10. The method of claim 1, wherein providing the interface for answering semantic queries comprises generating for display a graphical query builder based on the generated semantic structure.

11. A system comprising:
control circuitry configured to:
access at least one data source;
extract metadata from the at least one data source to generate a plurality of tags, wherein each of the plurality of tags is marked with one of a: structure class, structure attribute class, record class, and record attribute class;
generate, using an LLM, a vector embedding for each tag of the plurality of tags;
generate pairwise comparison data between the generated vector embeddings;
generate a set of candidate record groupings based on the pairwise comparison data, wherein match confidence levels are used to generate different candidate groups for the set of candidate record groupings;
I/O circuitry configured to:
generate for display a user interface that hierarchically represents each grouping of the set of candidate record groupings;
receive input via the user interface for excluding at least one candidate record grouping from the set of candidate record groupings;
wherein the control circuitry is further configured to:
adjust the candidate record groupings based on the input;
generate a semantic structure comprising classes, attributes, and class links based on the adjusted candidate record groupings; and
wherein the I/O circuitry is further configured to:
provide an interface for answering semantic queries based on the generated semantic structure.

12. The system of claim 11, wherein the control circuitry is further configured to generate the plurality of tags based at least in part on receiving a second input via the user interface of local identifiers.

13. The system of claim 12, wherein the control circuitry is further configured to generate the plurality of tags based at least in part on:
splitting text corresponding to the at least one data source to generate a plurality of tokens; and
analyzing each token of the plurality of tokens to determine at least one of: a local identifier, a single character, a numeric, a known vocabulary word, or a known acronym.

14. The system of claim 11, wherein the control circuitry is further configured to:
analyze each tag of the plurality of tags to determine the unique attribute; and
wherein the generating the vector embedding for each tag of the plurality of tags is based at least in part on the unique attribute of the respective tag.

15. The system of claim 11, wherein the control circuitry is further configured to:
generate, using the LLM, a name for each grouping of the set of candidate record groupings based on tag values of members of the respective grouping.

16. The system of claim 11, wherein the control circuitry is further configured to:
roll up metadata from tags at a first level in a hierarchy to tags at a second level in the hierarchy prior to generating the set of candidate record groupings, wherein the second level is a parent level of the first level.

17. The system of claim 11, wherein the control circuitry is configured to generate the pairwise comparison data by comparing the vector embeddings using cosine similarity.

18. The system of claim 11, wherein the control circuitry is configured to adjust the candidate record groupings by assigning children of the excluded candidate record grouping to a parent of the excluded candidate record grouping.

19. The system of claim 11, wherein the control circuitry is further configured to export the semantic structure to at least one of: a knowledge graph or an ontology file.

20. The system of claim 11, wherein the control circuitry is configured to provide the interface for answering semantic queries by generating for display, via the I/O circuitry, a graphical query builder based on the generated semantic structure.
